(19) United States
(12) Patent Application Publication
(10) Pub. No.: US 2025/0249368 A1
(43) Pub. Date: Aug. 7, 2025

(54) PROGRAM, METHOD, INFORMATION PROCESSING DEVICE, AND SYSTEM

(71) Applicant: The Pokémon Company, Tokyo (JP)

(72) Inventors: Keita HIROBE, Tokyo (JP); Takuya HASHIMOTO, Tokyo (JP); Satoki NAKAMURA, Tokyo (JP); Shunsuke TAKAGI, Tokyo (JP)

(73) Assignee: The Pokémon Company, Tokyo (JP)

(21) Appl. No.: 19/188,043

(22) Filed: Apr. 24, 2025

Related U.S. Application Data
(63) Continuation of application No. PCT/JP2023/037798, filed on Oct. 19, 2023.

(30) Foreign Application Priority Data
Oct. 27, 2022 (JP) 2022-172296

(51) Int. Cl. A63F 13/80

(52) U.S. Cl. CPC A63F 13/80

(57) ABSTRACT

A program is to be executed by a computer including a processor and a memory. The program causes the processor to perform the steps of receiving, from a first player, a request to register a deck created by combining a plurality of digital cards; determining whether predetermined conditions are satisfied, the predetermined conditions including the condition that the deck having received the request for registration from the first player is the first created deck; registering, if the predetermined conditions are satisfied, the deck in association with the first player who first created the deck; and allowing a second player to access information about the registered deck and the information about the deck to include information about the first player who created the deck.

### CROSS-REFERENCE TO RELATED APPLICATIONS

The present application is a continuation of International Application No. PCT/JP2023/037798, filed Oct. 19, 2023, which claims priority to Japanese Patent Application No. 2022-172296, filed Oct. 27, 2022, the entire contents of each are incorporated herein by reference.

### TECHNICAL FIELD

The present disclosure relates to a program, a method, an information processing device, and a system.

### BACKGROUND

Recently, digital trading card games (TCGs) played using digital cards have received attention.

### CITATION LIST

### Patent Literature

[PTL 1] Japanese Patent Application Laid-open No. 2013-034624

### SUMMARY

### Technical Problems

In digital TCGs, owned digital cards are combined to build a deck in preparation for a battle with another player or a CPU. Construction of decks such as a strong deck and a characteristic deck is part of TCG entertainment.

PTL 1 describes that a player creates a deck and registers the created deck for each game to be used. However, PTL 1 does not describe the improvement of the fun of creating a deck.

An object of the present disclosure is to improve the fun of creating a deck.

### Solutions to Problems

A program to be executed by a computer includes a processor and a memory. The program causes the processor to perform the steps of: receiving, from a first player, a request to register a deck created by combining a plurality of digital cards; determining whether predetermined conditions are satisfied, the predetermined conditions including the condition that the deck having received the request for registration from the first player is the first created deck; registering, if the predetermined conditions are satisfied, the deck in association with the first player who first created the deck; and allowing a second player to access information about the registered deck and the information about the deck to include information about the first player who created the deck.

### Advantageous Effects

According to the present disclosure, the fun of creating a deck can be improved.

### BRIEF DESCRIPTION OF DRAWINGS

FIG. 1 shows a phase for preparing a TCG battle according to one or more aspects of the disclosed subject matter.

FIG. 2 shows a phase for starting a TCG battle according to one or more aspects of the disclosed subject matter.

FIG. 3 shows a phase in which each user is proceeding with a TCG battle.

FIG. 4 is a block diagram illustrating an example of the overall configuration of a system.

FIG. 5 is a block diagram of a configuration example of a terminal device shown in FIG. 4.

FIG. 6 shows an example of the functional configuration of a server.

FIG. 7 shows the data structure of card information.

FIG. 8 shows the data structure of deck information.

FIG. 9 shows the data structure of a user information table.

FIG. 10 shows the data structure of a card master table.

FIG. 11 shows the data structure of a deck information table.

FIG. 12 shows the data structure of a battle information table.

FIG. 13 shows the data structure of a bonus information table.

FIG. 14 is a schematic view illustrating an example of a deck list displayed on the terminal device.

FIG. 15 is a schematic view showing a display example of a display.

FIG. 16 is a schematic view illustrating an example of the edit screen of a deck displayed on the terminal device.

FIG. 17 is an explanatory drawing showing an operation example of the terminal device and the server when a user registers a deck.

FIG. 18 is a schematic view showing a display example of the display.

FIG. 19 is a flowchart showing an operation example of the server when a deck is registered.

FIG. 20 is a schematic view showing a display example of the display.

FIG. 21 is a schematic view showing a display example of the display.

FIG. 22 is a flowchart showing an operation example of the server when a deck is registered.

FIG. 23 is a schematic view showing a display example of the display.

FIG. 24 is a flowchart showing an operation example of the server when the deck and the creator of the deck are associated with each other.

FIG. 25 is a schematic view showing a display example of the display.

FIG. 26 is an explanatory drawing showing an operation example of the terminal device and the server when battle information about the deck is managed.

FIG. 27 is a schematic view showing a display example of the display.

FIG. 28 is a block diagram illustrating a basic hardware configuration of a computer.

### DETAILED DESCRIPTION

Hereinafter, the present disclosure will be described with reference to the drawings. In the following description, the same parts are denoted by the same reference numerals. The names and functions thereof are also the same. Thus, a detailed description thereof will not be repeated.

### Overview

A program according to a present embodiment registers, when predetermined conditions including the condition that a deck created by a player is a first created deck are satisfied, the deck in association with a first player who first created the deck. Information about the registered deck includes information about the first player and is published by the first player or access from the first player and the player.

An outline of a TCG according to the present embodiment will be first described below. Thereafter, a card management system will be described.

### <0 Outline of TCG>

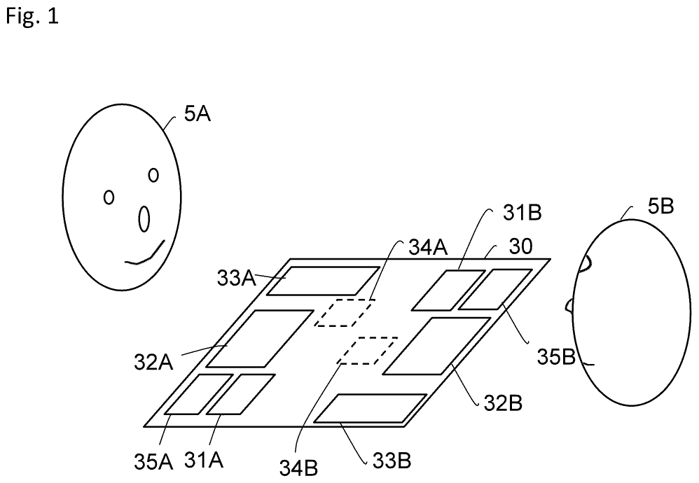

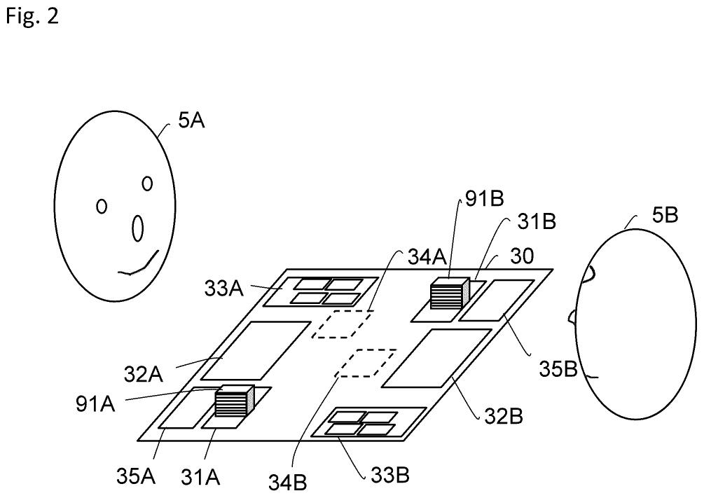

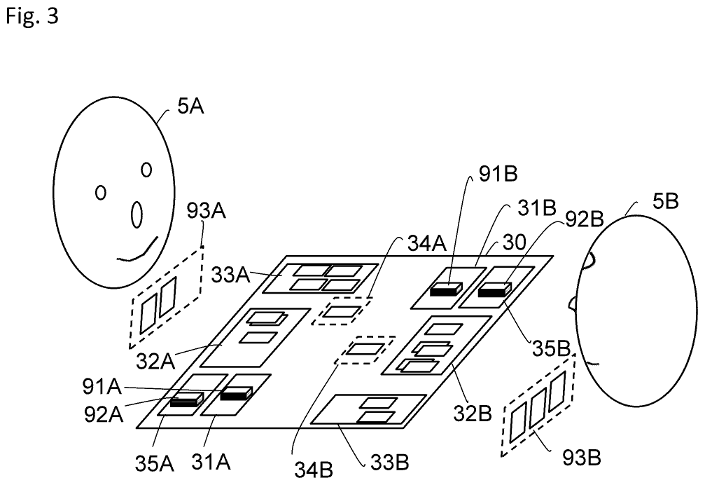

FIG. 1 shows a phase for preparing a TCG battle according to the present embodiment. FIG. 2 shows a phase for starting a TCG battle according to the present embodiment. FIG. 3 shows a phase in which each user is proceeding with a TCG battle.

A user places a play mat 30 and fights a TCG battle using a deck constructed by combining cards to be used for the TCG battle.

### <0.1 Configuration of Play Mat 30>

Referring to FIG. 1, various items used by each user in a TCG battle will be described below. As shown in FIG. 1, the play mat 30 is placed between a user 5A (first user) and a user 5B (second user) to start a TCG battle between the user 5A and the user 5B. The play mat 30 is placed to arrange cards included in the deck. Each user places cards as a stock or the like on the play mat 30 and proceeds with a TCG battle while adding cards to the hand from the stock.

The configuration of the play mat 30 will be described below. The play mat 30 includes, for example, a mat that indicates a position where a card is placed. The play mat 30 includes, for example, a stock placement part 31A and a stock placement part 31B (hereinafter may be generically called “stock placement part 31”), a prepared-card placement part 32A and a prepared-card placement part 32B (hereinafter may be generically called “prepared-card placement part 32”), a win/loss condition card placement part 33A and a win/loss condition card placement part 33B (hereinafter may be generically called “win/loss condition card placement part 33”), a battle-card placement part 34A and a battle-card placement part 34B (hereinafter may be generically called “battle-card placement part 34”), and a consumed-card placement part 35A and a consumed-card placement part 35B (hereinafter may be generically called “consumed-card placement part 35”).

As shown in FIG. 3, in a TCG battle, users proceed with a battle between cards while replenishing hands with cards from stocks. In the example of FIG. 3, the user 5A has a hand 93A (two cards for the hand in the example of FIG. 3). The user 5B has a hand 93B (three cards for the hand in the example of FIG. 3).

The stock placement part 31 is an area for arranging some of the cards constituting the deck owned by each user. The stock placement part 31A is an area where the user 5A places cards as a stock. The stock placement part 31B is an area where the user 5B places cards as a stock.

As shown in FIG. 2, when each user starts a TCG battle, each user mixes cards constituting the deck and places the cards face down in the stock placement part 31. The user 5A places the cards as a stock 91A in the stock placement part 31A. The user 5B places the cards as a stock 91B in the stock placement part 31B.

The prepared-card placement part 32 is an area for preparing cards for a battle against the cards of the opponent. The users fight each other with cards placed in the battle-card placement part 34 while exchanging the cards placed in the prepared-card placement part 32 and the cards placed in the battle-card placement part 34.

As shown in FIG. 2, before the start of a TCG battle, no cards are placed in the prepared-card placement part 32 and the battle-card placement part 34. In contrast, as the TCG battle proceeds as shown in FIG. 3, the users place the cards in the prepared-card placement part 32 and the battle-card placement part 34 and fight each other with the cards in the battle-card placement part 34. The users place the cards to be used for the battle in the prepared-card placement part 32 and the battle-card placement part 34 from the hands while replenishing the hands with the cards from the stocks. The user 5A places the cards in the prepared-card placement part 32A. The user 5B places the cards in the prepared-card placement part 32B.

The win/loss condition card placement part 33 is an area indicating the level of satisfaction of win conditions by each player. In the present embodiment, with regard to the win/loss condition card placement part 33, each player places a predetermined number of cards face down in the win/loss condition card placement part 33 from the stock. As shown in FIG. 2, the user 5A places the cards in the win/loss condition card placement part 33A. The user 5B places the cards in the win/loss condition card placement part 33B.

The battle-card placement part 34 is an area for placing a card against a card of the opponent. The user 5A places the card in the battle-card placement part 34A. The user 5B places the card in the battle-card placement part 34B. In the present embodiment, basically, a card placed in the battle-card placement part 34A and a card placed in the battle-card placement part 34B fight against each other on the basis of a physical strength set for each card, an offensive strength, the attributes of a character shown on each card, the attributes of weak points, and other parameters. The card placed in the battle-card placement part 34 is damaged according to, for example, the offensive strength, the attributes of the card, and the weak points, and the physical strength is reduced according to the damage. When the physical strength set for the card is lost due to an attack or the like, the card is caused to retreat from the battle-card placement part 34 and is placed in the consumed-card placement part 35.

The consumed-card placement part 35 is an area for placing cards consumed in TCG battles. For example, cards that have lost physical strengths in battles and cards that have activated the effects are placed in the consumed-card placement part 35. As shown in FIG. 3, the user 5A places cards consumed in battles, as cards 92A in the consumed-card placement part 35A. The user 5B places cards consumed in battles, as cards 92B in the consumed-card placement part 35B.

The cards placed in the consumed-card placement part 35 can be placed in the stock placement part 31, the prepared-card placement part 32, and the hand or the like by activating the effect of a predetermined card. The play mat 30 may further include an area for placing cards consumed in battles, in addition to the consumed-card placement part 35. The area is referred to as, for example, a second consumed-card placement part. The card placed in the second consumed-card placement part does not return to the original part even when the effect of the predetermined card is activated. It should be noted that the predetermined effect may be achieved depending on the number of cards placed in the second consumed-card placement part.

### <0.2 Type of Card Used in TCG>

In a TCG of the present embodiment, types of cards include (i) a character card usable for a battle, (ii) an action power card (energy card) used in association with a character card, and (iii) an effect card (a support card, a goods card, a stadium card or the like) for activating a specific effect during a battle.

(i) Character cards include a card (also referred to as “unconditional card”) that can be placed in the prepared-card placement part 32 or the battle-card placement part 34 when being drawn from the stock and added to the hand by the user, and a card (also referred to as “conditional card”) that can be placed in the prepared-card placement part 32 or the battle-card placement part 34 when meeting a specific condition.

(iA) For example, a conditional card can be placed provided that an unconditional card associated with the conditional card is placed. For example, following the evolution of a character, first, an unconditional card is presented to the other user by placing the unconditional card on the play mat 30, and then a conditional card associated with the unconditional card is placed on the play mat 30. Such conditional cards may also be referred to as “evolved characters” as evolved from unconditional cards. Unconditional cards may also be referred to as “seed characters” because the unconditional cards can also be regarded as original characters for placing “evolutionary characters”.

(iB) For example, a conditional card can be placed in the prepared-card placement part 32 or the battle-card placement part 34 by consuming a specific card and moving the card to the consumed-card placement part 35. Specifically, as a specific card, an unconditional card placed on the play mat 30 may be consumed (moved to the consumed-card placement part 35), and then the conditional card may be placed in the prepared-card placement part 32 or the battle-card placement part 34.

For example, a conditional card can be placed in the prepared-card placement part 32 or the battle-card placement part 34 in exchange with one or more character cards placed on the play mat 30 by the user. For example, when each character card is assigned with a parameter (e.g., an evolution level) indicating the overall performance of the character in addition to individual parameters such as the offensive strength of the character indicated on the card, a conditional card may be placed with an evolution level corresponding to the value of the evolution level of the character card placed by the user. For example, in a state in which a character with evolution level 1 and a character with evolution level 2 are placed on the play mat 30, a conditional card with evolution level 3 can be placed over the cards of these characters (or in exchange with these character cards).

In addition, the conditional card may be allowed to participate in a battle in exchange with a plurality of character cards determined by the conditional card. At this time, an auxiliary card, which is different from the character cards and will be described later, may be consumed to allow the conditional card to participate in the battle. For example, as an effect indicated on the auxiliary card, it is determined that a specific conditional card is allowed to participate in a battle in exchange with a specific unconditional card in, for example, the battle-card placement part 34 or the consumed-card placement part 35 on the play mat 30.

(iC) These cards also include cards serving as two or more of a character card, an action power card, which will be described later, and an auxiliary card. For example, a special card that can also be used as a character card and an auxiliary card may be included. The user can use the special card as a character card if the special card is placed at a position where the character card is to be placed (e.g., the prepared-card placement part 32 or the battle-card placement part 34).

(ii) An action power card (energy card) drawn from the stock and added to the hand by the user is placed in association with a character card on the play mat 30, enabling a predetermined action indicated on the character card. An operation for associating the action power card with the character card may be performed, for example, during the turn of the user. For example, the action power card may be associated with the character card by placing the action power card in the vicinity of the character card placed on the play mat 30. Furthermore, the number of times the action power card is associated with the character card may be limited during the turn. For example, once during the turn of the user, an action power card in the hand may be placed in association with one of character cards placed on the play mat 30. For example, it is assumed that a first attack action and a second attack action are set for a character card. The first attack action may be used when an action power card is associated with the character card, and the second attack action may be used when a single action power card is not sufficient and thus two action power cards are associated with the character card.

If the character card retreats from the battle-card placement part 34 due to exhaustion of the physical strength value by a battle or the like, the action power card associated with the character card may be disabled during the battle. Moreover, the action power card associated with the character card may be moved to the consumed-card placement part 35.

(iii) Auxiliary cards for assisting a battle include a type of card usable by any number by the user any number of times during a turn when being held in the hand of the user and a type of card usable alone during a turn. These auxiliary cards also include an auxiliary card that is made effective by declaring the use of the effect of the auxiliary card by the user.

The auxiliary cards further include an auxiliary card that is made effective by declaring the use of the auxiliary card with a voice or the like by the user in a state in which the auxiliary card is placed face down in advance at a predetermined position on the play mat 30.

### <0.3 Outline of TCG Battle Rules>

As described above, the play mat 30 used in a TCG battle and the card types have been described. The detail of the TCG battle rules will be described below.

In the TCG shown in the present embodiment, as described above, users proceed with a TCG battle by making an attack or defense (battle) on the basis of cards placed in the battle-card placement part 34A and the battle-card placement part 34B. It is assumed that the TCG battle proceeds when the users alternately act in each turn. For example, at the end of a turn after an action of the first user, the second user takes a turn. The second user acts in the turn, and at the completion of the action, the first user takes a turn.

Each user draws a predetermined number of cards from the stock and adds the cards to the hand in each turn.

From among the cards of the hand, each user places candidates for a card (character card) to be used for attack or defense of the user's card against an opponent in the prepared-card placement part 32.

The user 5A can exchange cards placed in the prepared-card placement part 32A and a card placed in the battle-card placement part 34A during the turn of the user 5A. Moreover, the user 5B can exchange cards placed in the prepared-card placement part 32A and a card placed in the battle-card placement part 34A during the turn of the user 5B.

As described above, the win/loss condition card placement part 33A and the win/loss condition card placement part 33B are areas for notifying each user about the progress of the battle under the conditions for each user to win a battle. In this case, the conditions for each user to win a battle may include, for example, the collection of all cards placed in the win/loss condition card placement part 33A or the win/loss condition card placement part 33B. In other words, the outcome of the battle may be determined when all the cards are collected from one of the win/loss condition card placement part 33A and the win/loss condition card placement part 33B.

For example, each user places a predetermined number of cards in the win/loss condition card placement part 33 prior to a TCG battle. In other words, the user 5A draws a predetermined number of cards from the stock 91A and places the cards in the win/loss condition card placement part 33A. The user 5B draws a predetermined number of cards from the stock 91B and places the cards in the win/loss condition card placement part 33B. The user 5A and the user 5B fight a battle with a character card placed in the battle-card placement part 34A and a character card placed in the battle-card placement part 34B. When the retreat conditions set for the character card are satisfied (for example, when the offensive strength set for the character card is subtracted to be exhausted on the basis of the offensive strength set for the character card of the opponent), the character card is moved to the consumed-card placement part 35 (also called “trash”) on the assumption that the character of the character card has fainted.

Thus, the user who has won the battle and ejected the character card of the opponent adds the card placed in the win/loss condition card placement part 33A or the win/loss condition card placement part 33B to the hand. For example, when the user 5B attacks the character card of the user 5A in the turn of the user 5B to eject the card placed in the battle-card placement part 34A, the user 5B draws a predetermined number of cards from the cards placed in the win/loss condition card placement part 33B and adds the cards to the hand. On the other hand, when the user 5A attacks the character card of the user 5B in the turn of the user 5A to eject the card placed in the battle-card placement part 34B, the user 5A draws a predetermined number of cards from the cards placed in the win/loss condition card placement part 33A and adds the cards to the hand. These operations are repeated. When the user 5B collects all the cards placed in the win/loss condition card placement part 33B or the user 5A collects all the cards placed in the win/loss condition card placement part 33A, the user who has collected the cards may be determined as the winning user of the TCG battle.

In addition, the win conditions of the battle may include a defeat in the absence of character cards in the battle-card placement part 34 and the prepared-card placement part 32. Furthermore, the win conditions of the battle may include a defeat when the user cannot draw cards from the stock placement part 31 in the turn of the user.

FIGS. 1 to 3 illustrate an example in which the users fight a TCG battle face-to-face. However, the TCG battle is not limited to a face-to-face battle between the users. The users to fight a battle may be connected via the Internet to acquire, for example, the voice of the opponent and the card layout of the opponent via the Internet. Specifically, for example, the users fight a battle while capturing images of the areas of the users on the play mat 30 with cameras or the like. The captured image is transmitted to the opponent in real time. The user receives an image of the area of the opponent from the opponent and displays the received image on the display. Thus, the user can confirm the cards of the opponent in real time through the screen while handling the real cards of the user. In this way, the users may fight an online TCG battle using analogue cards.

In the presence of a plurality of cameras or a device capable of adjusting the viewing angle of the camera, an image of the user's face may be captured and the captured image may be transmitted to the opponent. Thus, the facial expression of the opponent can be confirmed, so that the level of satisfaction in the online TCG battle can be ensured as in a face-to-face battle.

### <1 Configuration Diagram of Overall System>

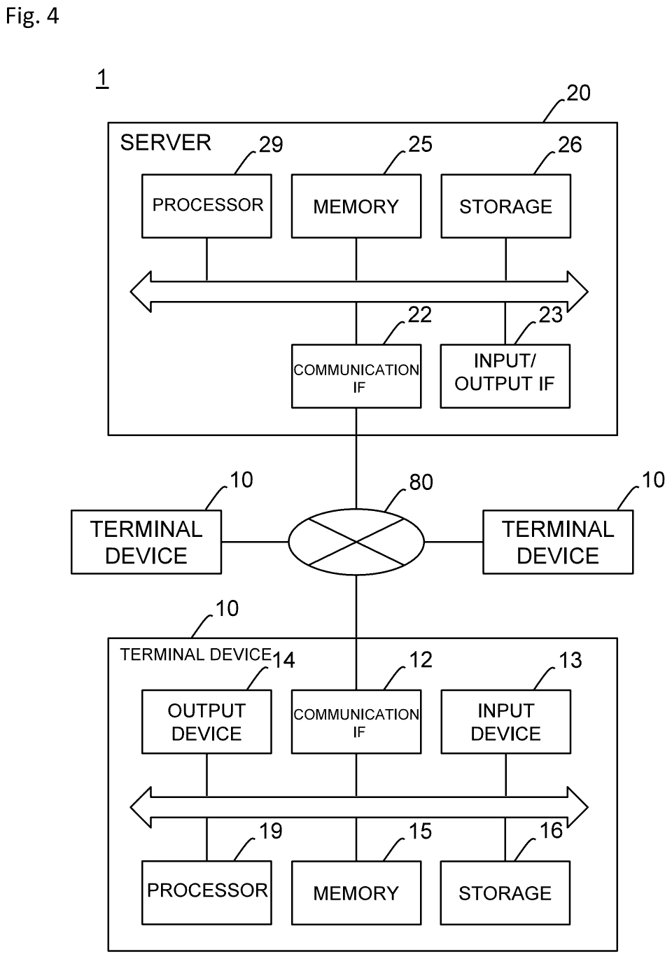

FIG. 4 is a block diagram illustrating an example of the overall configuration of a system 1. The system 1 illustrated in FIG. 4 includes, for example, terminal devices 10 and a server 20. For example, the terminal device 10 and the server 20 are communicatively connected via a network 80.

FIG. 4 shows an example in which the system 1 includes the three terminal devices 10. The number of terminal devices 10 included in the system 1 is not limited to three. The number of terminal devices 10 included in the system 1 may be two or less or four or more.

FIG. 4 shows an example in which the system 1 includes the single server 20. The number of servers 20 included in the system 1 is not limited to one. The server 20 may be composed of a plurality of servers depending on the functions of the server 20. Alternatively, the server 20 may be, for example, a single server configured as a set of multiple devices. A method for distributing multiple functions, which are required for implementing the server 20 according to the present embodiment, to one or more pieces of hardware can be determined as appropriate in consideration of, for example, the processing capability of each piece of hardware and/or specifications required for the server 20.

The terminal device 10 in FIG. 4 is, for example, an information processing device operated by a user playing a digital TCG. The terminal device 10 is implemented by, for example, a mobile terminal such as a smartphone or a tablet. The terminal device 10 may be implemented by a stationary PC (Personal Computer) or a laptop PC or may be implemented by a wearable terminal such as an HMD (Head Mount Display).

The terminal device 10 includes a communication IF (Interface) 12, an input device 13, an output device 14, a memory 15, a storage 16, and a processor 19. The input device 13 is a device (e.g., a touch panel or a touch pad) for receiving an input operation from the user. The output device 14 is a device (a display, a speaker or the like) for presenting information to the user.

The server 20 is, for example, an information processing device that manages card information and deck information.

The server 20 is implemented by, for example, a computer connected to the network 80. As shown in FIG. 4, the server 20 includes a communication IF 22, an input/output IF 23, a memory 25, a storage 26, and a processor 29. The input/output IF 23 functions as an interface between an input device for receiving an input operation from the user and an output device for presenting information to the user.

Each of the information processing devices is composed of a computer equipped with an arithmetic unit and a storage device. The basic hardware configuration of the computer and the basic functional configuration of the computer implemented by the hardware configuration will be described later. Regarding the terminal device 10 and the server 20, descriptions overlapping the basic hardware configuration of the computer and the basic functional configuration of the computer, which will be described later, will be omitted.

### <1.1 Configuration of Terminal Device>

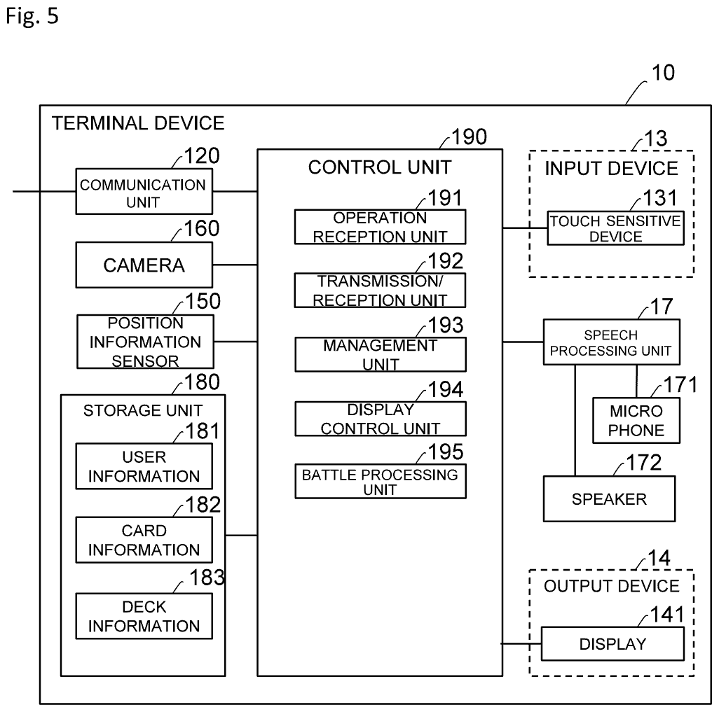

FIG. 5 is a block diagram of a configuration example of the terminal device 10 shown in FIG. 4. As illustrated in FIG. 5, the terminal device 10 includes a communication unit 120, the input device 13, the output device 14, a speech processing unit 17, a microphone 171, a speaker 172, a camera 160, a position information sensor 150, a storage unit 180, and a control unit 190. Blocks included in the terminal device 10 are electrically connected to one another via, for example, a bus.

The communication unit 120 performs processing such as modulation demodulation processing for the terminal device 10 communicating with another device. The communication unit 120 performs transmission processing on a signal generated by the control unit 190 and transmits the signal to the outside (for example, the server 20). The communication unit 120 performs reception processing on a signal received from the outside and outputs the signal to the control unit 190.

The input device 13 is a device that allows a user operating the terminal device 10 to input an instruction or information. The input device 13 is implemented by, for example, a touch sensitive device 131 to which an instruction is input by touching the operation surface. When the terminal devices 10 is a PC or the like, the input device 13 may be implemented by a reader, a keyboard, or a mouse or the like. The input device 13 converts an instruction input from the user into an electrical signal and outputs the electrical signal to the control unit 190. The input device 13 may include, for example, a reception port for receiving an electrical signal input from an external input device.

The output device 14 is a device for presenting information to the user operating the terminal device 10. The output device 14 is implemented by, for example, a display 141. The display 141 displays data under the control of the control unit 190. The display 141 is implemented by, for example, a liquid crystal display (LCD) or an organic electro-luminescence (EL) display.

For example, the speech processing unit 17 performs digital-to-analog conversion processing on an audio signal. The speech processing unit 17 converts a signal from the microphone 171 into a digital signal and supplies the converted signal to the control unit 190. Furthermore, the speech processing unit 17 provides the audio signal to the speaker 172. The speech processing unit 17 is implemented by, for example, a processor for speech processing. The microphone 171 receives a voice input and provides the speech processing unit 17 with an audio signal corresponding to the voice input. The speaker 172 converts the audio signal supplied from the speech processing unit 17 into a sound and outputs the sound to the outside of the terminal device 10.

The camera 160 is a device for receiving light through a light receiving element and outputting the light as a photographic signal.

The position information sensor 150 is a sensor that detects the position of the terminal device 10 and serves as, for example, a global positioning system (GPS) module. The GPS module is a receiving apparatus used in a satellite positioning system. The satellite positioning system receives signals from at least three or four satellites and detects the current position of the terminal device 10, which is equipped with the GPS module, on the basis of the received signals. The position information sensor 150 may detect the current position of the terminal device 10 from the position of a radio base station to which the terminal device 10 is connected.

The storage unit 180 is implemented by, for example, the memory 15 and the storage 16 or the like and stores data and programs that are used by the terminal device 10. For example, the storage unit 180 stores user information 181, card information 182, and deck information 183.

The user information 181 includes, for example, information about a user who plays a TCG. The information about the user includes, for example, a user ID and the name, the age, the address, the date of birth, the date of registration of the user, and information about another user followed by the user.

The card information 182 includes, for example, information about cards. The card information 182 may include information about cards owned by the user. The details will be described later.

The deck information 183 includes, for example, information about a deck constructed by the user. The details will be described later.

The control unit 190 is implemented by the processor 19 reading the program stored in the storage unit 180 and executing instructions included in the program. The control unit 190 controls an operation of the terminal device 10. The control unit 190 operates according to the program, thereby exhibiting the functions of an operation reception unit 191, a transmission/reception unit 192, a management unit 193, a display control unit 194, and a battle processing unit 195.

The operation reception unit 191 performs processing for receiving an instruction or information input from the input device 13. Specifically, for example, the operation reception unit 191 receives an instruction or information input from the touch sensitive device 131 or the like.

Furthermore, the operation reception unit 191 receives an image input from the camera 160. Specifically, for example, the operation reception unit 191 receives photographic data captured by the camera 160.

Moreover, the operation reception unit 191 receives speech information input from the microphone 171. Specifically, for example, the operation reception unit 191 receives voice data that is input from the microphone 171 and converted into digital data by the speech processing unit 17.

The transmission/reception unit 192 performs processing for the terminal device 10 transmitting or receiving data to or from an external device such as the server 20 according to a communication protocol. Specifically, for example, the transmission/reception unit 192 transmits an instruction input from the user or various types of acquired information to the server 20. The transmission/reception unit 192 also receives information provided from the server 20. The information provided from the server 20 includes, for example, information about a card additionally acquired by the user or information about a deck.

The management unit 193 manages the user information 181, the card information 182, and the deck information 183 that are stored in the storage unit 180. For example, when information about the user is edited, the management unit 193 stores the edited information in the user information 181. The management unit 193 updates the card information 182 when the information about the card is updated. In addition, the management unit 193 updates the deck information 183 when the information about the deck is updated.

The display control unit 194 controls the output device 14 to display a predetermined image for the user. For example, on the basis of the information managed by the card information 182 and the information managed by the deck information 183, the display control unit 194 controls the display 141 so as to display a management screen for a card owned by the user. Furthermore, the display control unit 194 controls the display 141 so as to display information about the deck.

The battle processing unit 195 controls battle processing against another deck. For example, battles are intended to represent the following types.
A battle against a CPU with a deck constructed with digital cards
A battle against another player with a deck constructed with digital cards
A battle against another player with analog cards read by a camera
A battle in a tournament

### <1.2 Functional Configuration of Server>

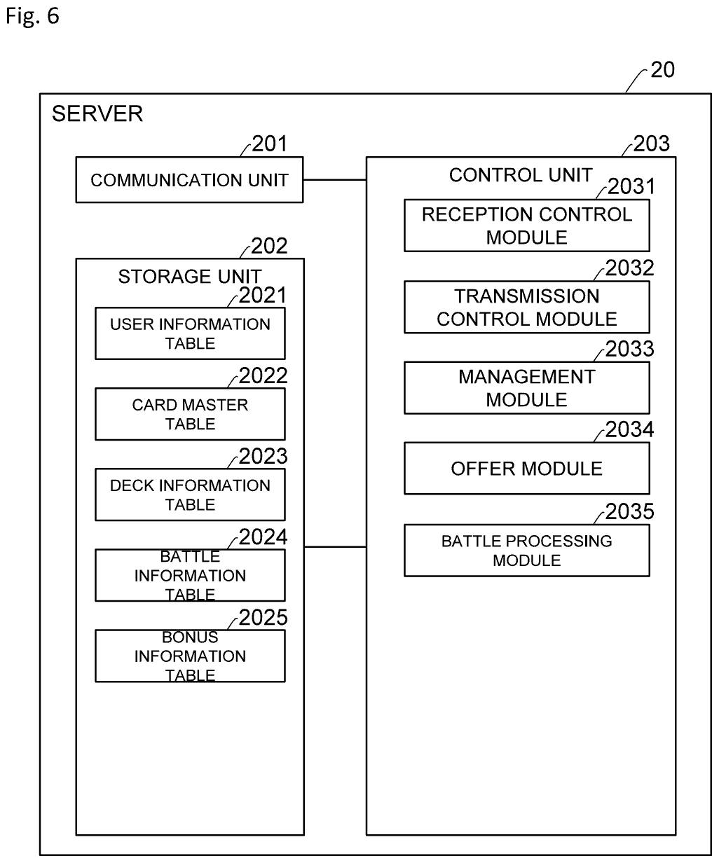

FIG. 6 shows an example of the functional configuration of the server 20. As illustrated in FIG. 6, the server 20 functions as a communication unit 201, a storage unit 202, and a control unit 203.

The communication unit 201 performs processing for the server 20 communicating with an external device.

The storage unit 202 includes, for example, a user information table 2021, a card master table 2022, a deck information table 2023, a battle information table 2024, and a bonus information table 2025.

The user information table 2021 is, for example, a table for storing information about users registered for TCG service. The details will be described later.

The card master table 2022 is, for example, a table for storing information about cards available for users. The details will be described later.

The deck information table 2023 is, for example, a table for storing information about a deck registered by the user. The details will be described later.

The battle information table 2024 is, for example, a table for storing information about battles fought in the past. The details will be described later.

The bonus information table 2025 is, for example, a table for storing information about bonuses (bonus information) to be offered to users. The details will be described later.

The control unit 203 is implemented by the processor 29 reading the program stored in the storage unit 202 and executing instructions included in the program. The control unit 203 operates according to the program, thereby exhibiting the functions of a reception control module 2031, a transmission control module 2032, a management module 2033, an offer module 2034, and a battle processing module 2035.

The reception control module 2031 controls processing for the server 20 receiving a signal from an external device according to the communication protocol.

The transmission control module 2032 controls processing for the server 20 transmitting a signal to an external device according to the communication protocol.

The management module 2033 manages tables stored in the storage unit 202. Specifically, for example, when receiving an instruction about the deck, the management module 2033 updates the deck information table 2023 on the basis of the received instruction. When receiving information about battles, the management module 2033 updates the deck information table 2023 and the battle information table 2024 on the basis of the received information.

The offer module 2034 offers a bonus to the user. For example, the offer module 2034 refers to the bonus information table 2025 to offer a bonus to a user meeting the conditions.

The battle processing module 2035 controls battle processing between users. For example, the battle processing module 2035 controls a battle between players using decks constructed with digital cards. Moreover, the battle processing module 2035 controls a battle fought between players with analog cards read by a camera.

### <2 Data Structure>

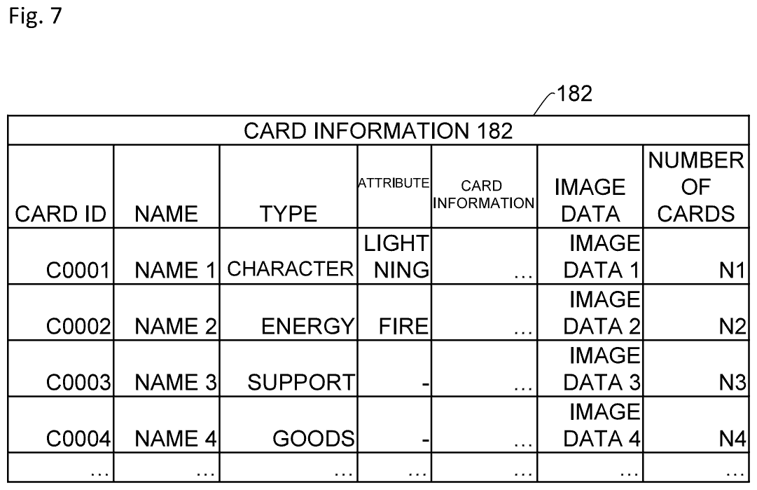

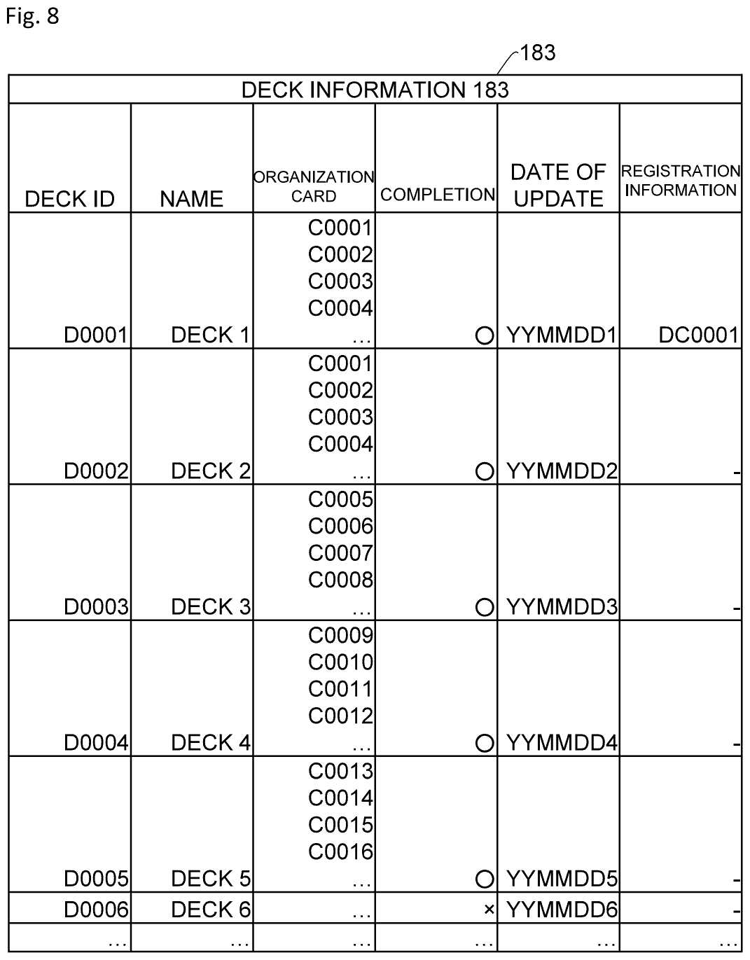

FIGS. 7 and 8 show the data structures of information stored in the terminal device 10. FIGS. 7 and 8 are merely exemplary and do not exclude data not shown in the drawings.

FIG. 7 shows the data structure of the card information 182. The card information 182 shown in FIG. 7 is a table including the columns of a name, a type, an attribute, card information, image data, and the number of cards with a card ID serving as a key. The card information 182 may include a card management ID for uniquely identifying completely identical cards, regulations, or information about rarity in addition to these items of information.

The card ID is an item that stores an identifier for uniquely identifying a card type. In the present embodiment, the same card ID is assigned to completely identical cards. Even with the same name, different card IDs are assigned to cards with different effects, cards with different rarities, and cards with different regulations. The name is an item that stores a card name. The type is an item that stores a card type. In the present embodiment, the types of cards include, for example, a character, an energy, a support, goods, and a stadium.

The attribute is an item that stores a property to which a character belongs. In the present embodiment, attributes include, for example, fire, water, lightning, grass, super, steel, evil, and fight. Attributes include attributes that will be advantageous and attributes that will be disadvantageous relative to each other. The card information is an item that stores information describing the contents of cards. When a card type is a character, the card information includes, for example, offensive strength, physical strength, energy required for techniques, energy required for escape, weak points, resistance, and special characteristics of characters. When card types are support, goods, and a stadium, the card information includes, for example, requirements for card use and effects obtained when a card is used.

Image data is an item that stores an image. The image data may store reference information (paths) for image data files placed at other locations. The number of cards is an item that stores the number of cards that are owned by the user and are assigned with the same card ID. In the present embodiment, different card IDs are assigned to cards having different effects even if the cards have the same name. In addition, different card IDs are assigned to cards having different rarities even if the cards have the same name. Moreover, different card IDs are assigned to cards having different regulations even if the cards have the same name. If owned cards are managed uniquely by card management IDs, the number of cards may not be managed.

FIG. 8 shows the data structure of the deck information 183. The deck information 183 in FIG. 8 is a table including the columns of a name, an organization card, completion, a date of update, and registration information with a deck ID serving as a key. The deck information 183 may include information about the common name of the deck, the usage history of the deck, and representative images in addition to these items of information. The common name of the deck is, for example, a name that is assigned on the basis of characteristic cards used for the deck and is assigned with a common recognition among a plurality of users, the name directly representing the characteristics of the deck. The representative image is, for example, an image of a card specified by the user from among cards organized in the deck. The representative image is, for example, an image related to an illustration except for text in the description of the card. For example, the representative image is an image such as a thumbnail image in which the number of pixels is reduced to a predetermined number.

The deck ID is an item that stores an identifier for uniquely identifying a deck. The name is an item that stores the name of the deck. The name is generated on the basis of, for example, a part of a card for organizing the deck or is assigned by the user. The organization card is an item that stores cards for organizing the deck. The organization card stores, for example, the card ID of a card for organizing the deck.

Completion is an item that stores whether the deck has been completed or not. In the present embodiment, a circle indicates that the deck has been completed, whereas a cross indicates that the deck has not been completed. In the present embodiment, for example, the completion of the deck means that the deck including a predetermined number of cards is available for a battle. The date of update is an item that stores the date on which the configuration of the deck is changed. In the calculation of the date of update, as a change, cards used for one deck may be employed for another deck. The registration information is an item that stores a relationship with the deck registered in the server 20. The registration information stores, for example, a deck code issued when the deck is registered in the server 20.

A deck record is added when a new deck is created in the terminal device 10 in response to a user instruction.

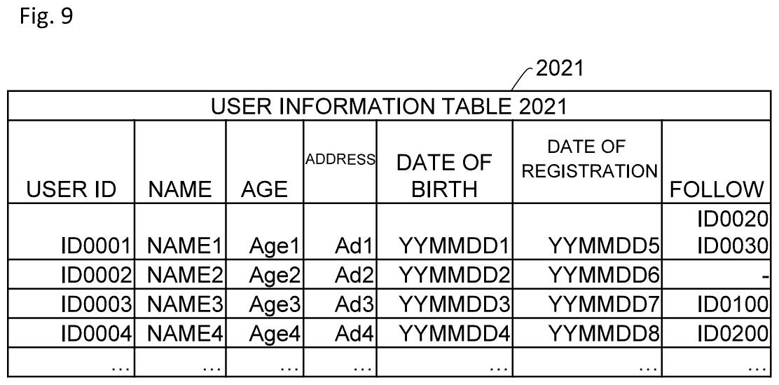

FIGS. 9 to 13 show the data structures of information stored in the server 20. FIGS. 9 to 13 are merely exemplary and do not exclude data not shown in the drawings.

FIG. 9 shows the data structure of the user information table 2021. The user information table 2021 in FIG. 9 is a table including the columns of a name, an age, an address, the date of birth, the date of registration, and follow with a user ID serving as a key. The user information table 2021 may include a skill level as a column in addition to the above items.

The user ID is an item that stores an identifier for uniquely identifying the user. The user name is an item that stores the name of the user. The age is an item that stores the age of the user. The address is an item that stores the location where the user lives. The date of birth is an item that stores the date on which the user was born. The date of registration is an item that stores the date on which the user began to use the TCG service. The follow is an item that stores information about another user followed by the user. The follow stores, for example, the user ID of another user followed by the user.

Records in the user information table 2021 are added when a user is newly registered.

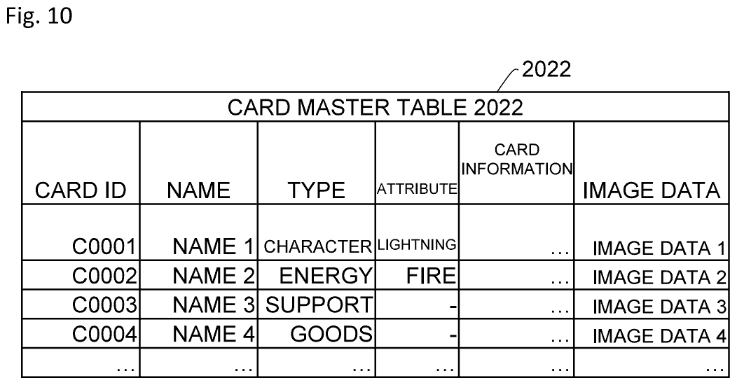

FIG. 10 shows the data structure of the card master table 2022. The card master table 2022 in FIG. 10 is a table including the columns of a name, a type, an attribute, card information, and image data with a card ID serving as a key.

The card ID is an item that stores an identifier for uniquely identifying a card type. The name is an item that stores a card name. The type is an item that stores a card type. The attribute is an item that stores a property to which a character belongs. The card information is an item that stores information describing the contents of cards. The image data is an item that stores an image.

Records in the card master table 2022 are added, for example, when a card is newly issued.

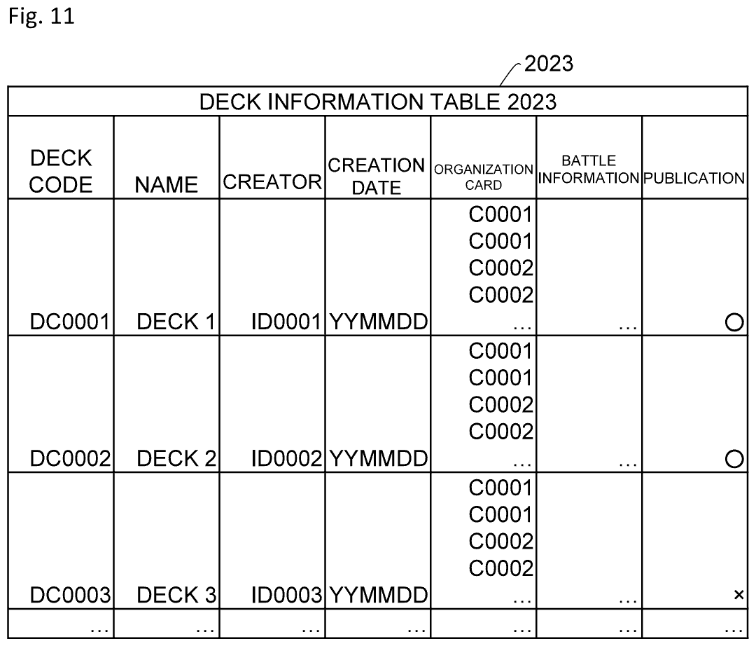

FIG. 11 shows the data structure of the deck information table 2023. The deck information table 2023 in FIG. 11 is a table including the columns of a name, a creator, a creation date, an organization card, battle information, and publication with a deck code serving as a key. In addition to these items of information, the deck information table 2023 may include information about the common name of the deck, a representative image, a registrant, the number of views, the date of a user request for registration, and the date on which the use of the deck has reached predetermined conditions. The registrant stores, for example, users other than the creator from among users who have registered decks. In other words, the registrant represents the user ID of a user who created and registered the deck second or later. The registrant may further include information that can distinguish between registrants. For example, numbers may be included to allow recognition of the order of registration. Specifically, when “1” is assigned to the creator, “2” is assigned to the first registrant. When “1” is assigned to the first registrant, “2” may be assigned to the next registrant. Thus, the users can recognize the order in which the users started to use the corresponding deck. For example, the users can be aware of being ahead of the trend. The number of views stores, for example, the number of users who have confirmed the contents of the deck. When the server 20 provides the function to copying the deck organization, the number of users who have copied the deck organization may be stored as the number of references.

The deck code is an item that stores an identifier for uniquely identifying a registered deck. The deck code is issued by management module 2033 when the deck is requested by the user to be published is a new deck. A new deck represents, for example, a deck at least partially different from an existing deck. In 1 other words, a new deck may represent, for example, a deck in a state in which no decks have exactly the same configuration. For example, the deck code in FIG. 11 has an identifier different from that of the deck ID shown in FIG. 8. This is because the deck code in FIG. 11 is set to manage a published deck while the deck ID in FIG. 8 is set to manage the deck of the user.

The name is an item that stores the name of the deck. The name is assigned by the user. The creator is an item that stores the user ID of the user who first created the deck. The creation date is an item that stores the date on which the deck was first created. The organization card is an item that stores cards for organizing the deck. The organization card stores, for example, the card ID of a card for organizing the deck. The battle information is an item that stores information about a battle fought with a deck identified by the deck code. The battle information includes, for example, following information:
A battle ID for identifying a battle
Date and time of a battle
A tournament in which the user has participated
A tournament result

The publication is an item that stores whether the deck has been published to other users. In the present embodiment, a circle indicates that the deck has been published to other users, whereas a cross indicates that the deck has not been published to other users. In the present embodiment, the unpublished deck means that only the user can confirm the deck.

Records in the deck information table 2023 are added when a deck is newly registered.

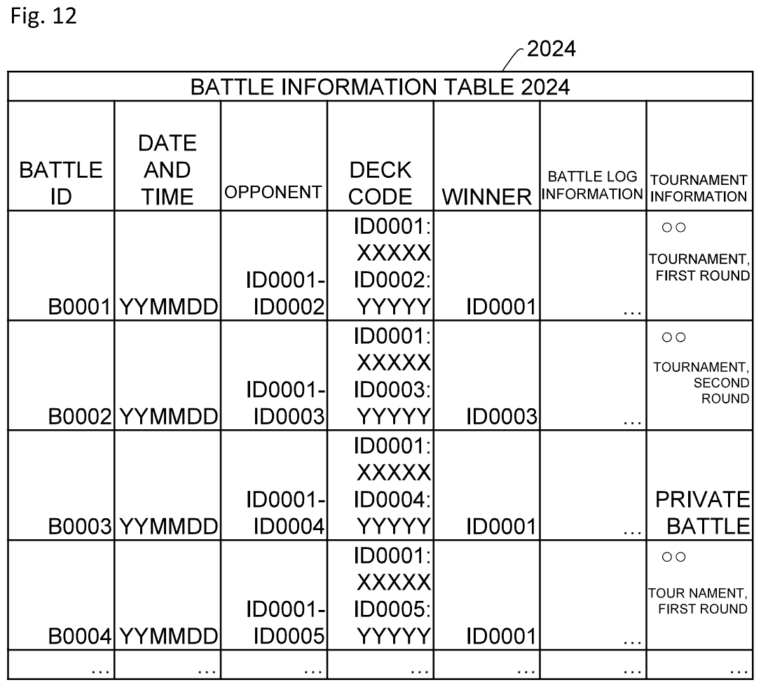

FIG. 12 shows the data structure of the battle information table 2024. The battle information table 2024 in FIG. 12 is a table including the columns of a date and time, an opponent, a deck code, a winner, battle log information, and tournament information with a battle ID serving as a key.

The battle ID is an item that stores an identifier for uniquely identifying a battle. The battle ID is issued by the management module 2033 when new information about a battle is registered. The date and time is an item that stores a date and time of a battle. The opponent is an item that stores information about a player who has fought a battle. In the present embodiment, for example, the user IDs of players who have fought a battle are stored in the opponent.

The deck code is an item that stores a code for identifying a deck used in a battle. In the present embodiment, for example, a player who has fought a battle and the deck code of a deck used by the player are associated with each other. The deck code is not necessarily stored. In other words, the deck code may be unregistered. If the deck code is not registered, for example, the item “deck code” may store information representing the deck, which is determined from the contents of a card included in the deck. At this time, for example, the management module 2033 creates information representing the deck on the basis of the card included in the deck and stores the created information in the item “deck code”. For example, the management module 2033 creates information representing the deck on the basis of the name of a main card included in the deck. The management module 2033 may also store information about cards included in the deck, in the item “deck code”.

The winner is an item that stores the winner of a battle. The battle log information is an item that stores techniques adopted by a player during a battle. Specifically, for example, the battle log information includes: drawing a card from a predetermined placement part (a stock or win/loss condition cards or the like) by the player; placing the card in the predetermined placement part by the player; and using the effect of a predetermined card by the player. A technique adopted by the player in a battle may also be referred to as a deck shuffle. The tournament information is an item that stores information about battles. For example, the tournament information includes the tournament name of a battle and the number of battle rounds in a tournament. The tournament information may include battle information about private tournaments as well as public tournaments. Furthermore, the tournament information is not limited to tournaments and may include battle information about private battles.

Records in the battle information table 2024 are added when a battle is newly registered.

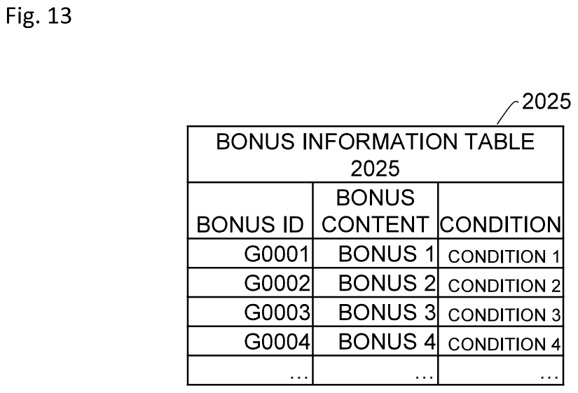

FIG. 13 shows the data structure of the bonus information table 2025. The bonus information table 2025 in FIG. 13 is a table including the columns of a bonus content and a condition with a bonus ID serving as a key.

The bonus ID is an item that stores an identifier for uniquely identifying a bonus. The bonus content is an item that stores the content of the bonus. The condition is an item that stores a condition where the bonus is offered.

### <3 Operation>

The operations of the terminal device 10 and the server 20 when the user constructs a deck and registers the constructed deck will be described below.

### (Construction of Deck)

The user operates the terminal device 10 to edit cards and constructs a deck composed of a plurality of digital cards.

The user inputs an instruction to the terminal device 10 to display a list of cards owned by the user. Specifically, for example, the user executes an application installed for a digital TCG in the terminal device 10. In the started application, the user inputs an instruction to the terminal device 10 to display the cards owned by the user. The control unit 190 of the terminal device 10 displays a list of cards on the display 141 by means of the display control unit 194 on the basis of the card information 182 and the deck information 183.

The user inputs an instruction to the terminal device 10 to display a list of decks owned by the user. Specifically, for example, the user touches an instruction object in the display of a card list to input an instruction to display a list of decks. The display control unit 194 displays a list of decks on the display 141 on the basis of the deck information 183. The user may start an application for a digital TCG installed in the terminal device 10 and input an instruction to the terminal device 10 to edit the deck in the started application.

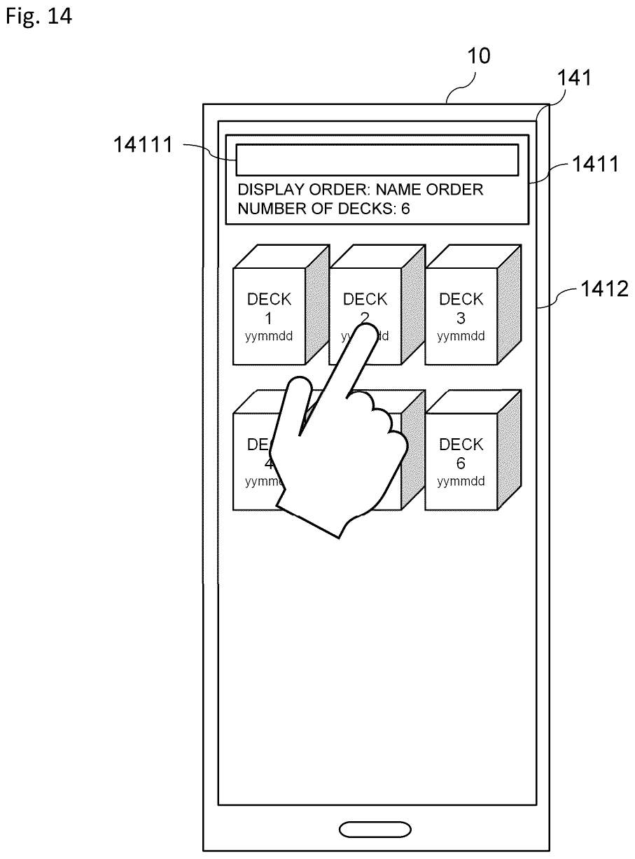

FIG. 14 is a schematic view illustrating an example of a deck list displayed on the terminal device 10. In FIG. 14, the display control unit 194 displays an area 1411 and an area 1412. The area 1412 is an area in which decks owned by the user are displayed in a mode conforming to display conditions shown in the area 1411.

In the example shown in FIG. 14, the display order is displayed as a display condition in the area 1411. The display order represents the rule of order. The display order is selected by the user from, for example, the numeric order, the name order, and the update date order. In the example shown in FIG. 14, “Display order: name order” is selected, and the decks are arranged in the order of arrangement of names in the area 1412.

In the area 1411, a search window 14111 is displayed. When a deck is desired, the user enters a keyword or the like in the search window 14111 to search for the desired deck.

When the user selects the deck, the display control unit 194 displays, on the display 141, processing executable on the deck selected by the user.

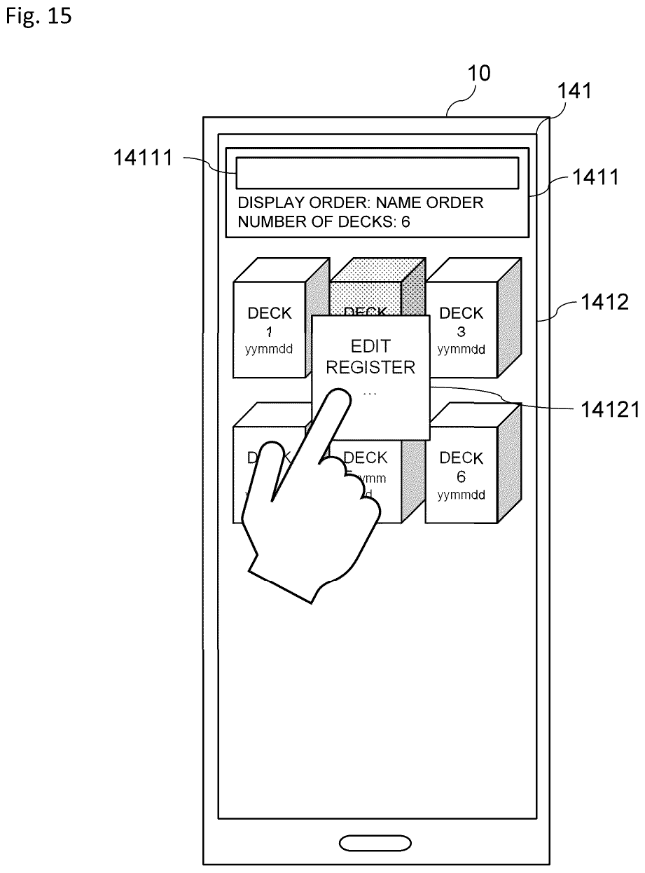

FIG. 15 is a schematic view showing a display example of the display 141. In the example shown in FIG. 15, the display control unit 194 displays a window 14121 in which processing for the decks is displayed as options in a list form. For example, the display control unit 194 displays, in the window 14121, edit and registration or the like as processing for the decks. The user selects processing for the decks by operating the input device 13.

The user inputs, for example, an instruction to the terminal device 10 to display the edit screen of the selected deck. Specifically, for example, the user selects “edit” in the window 14121 shown in FIG. 15. The display control unit 194 displays the edit screen of the deck on the display 141 on the basis of the card information 182 and the deck information 183.

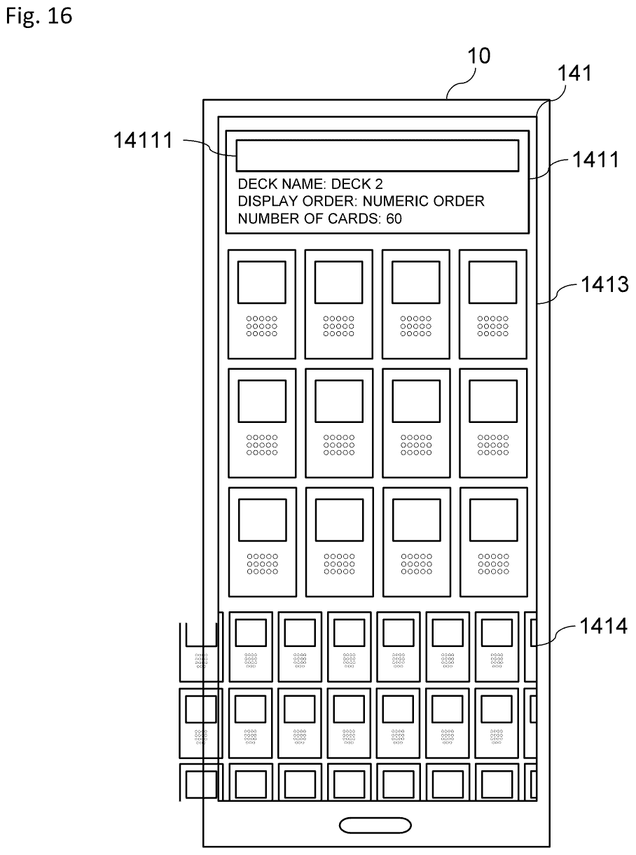

FIG. 16 is a schematic view illustrating an example of the edit screen of a deck 2 displayed on the terminal device 10. FIG. 16 shows the edit screen when the deck 2 is selected by the user. The user-selected deck is not limited to the deck 2. In FIG. 16, the display control unit 194 displays the area 1411, the area 1413, and an area 1414. The area 1413 is an area in which cards constituting the deck are displayed in a mode conforming to display conditions shown in the area 1411. The area 1414 is an area in which a list of cards owned by the user is displayed in a mode conforming to the display conditions shown in the area 1411. In the area 1414, cards are displayed so as to be replaced with the cards displayed in the area 1413. The cards displayed in the area 1413 may be displayed such that the cards are distinguishable from the cards displayed in the area 1414. In the example shown in FIG. 16, the cards displayed in the area 1413 are displayed larger than the cards displayed in the area 1414.

In the example shown in FIG. 16, the display order is displayed as a display condition in the area 1411. The display order represents the rule of order. The display order is selected by the user from, for example, the numeric order, the name order, the rarity order, and the acquisition date order. In the example shown in FIG. 16, “Display order: numeric order” is selected, and the cards are arranged in the order of arrangement of card IDs in the areas 1413 and 1414.

### (Registration of Deck)

The user operates the terminal device 10 to register the constructed deck.

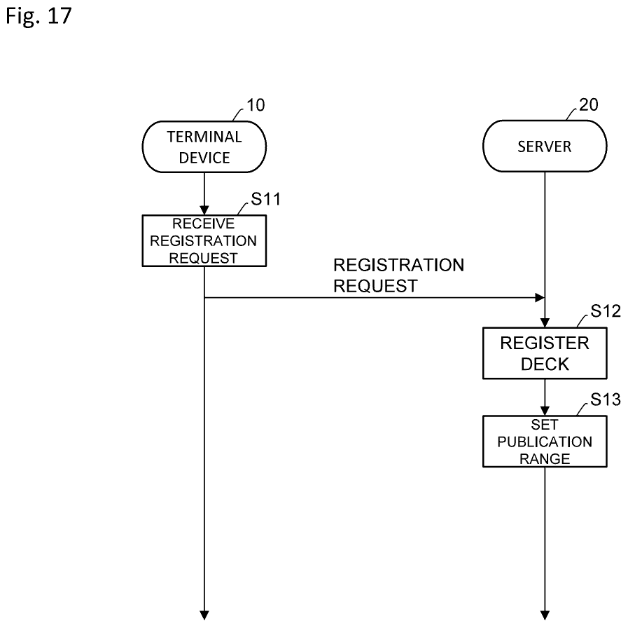

FIG. 17 is an explanatory drawing showing an operation example of the terminal device 10 and the server 20 when the user registers a deck.

For example, the user operates the terminal device 10 to select a desired deck and inputs an instruction to register the selected deck. Specifically, for example, the user selects “register” in the window 14121 shown in FIG. 15.

When the user selects “register”, the terminal device 10 displays the screen for confirming the deck by means of the display control unit 194.

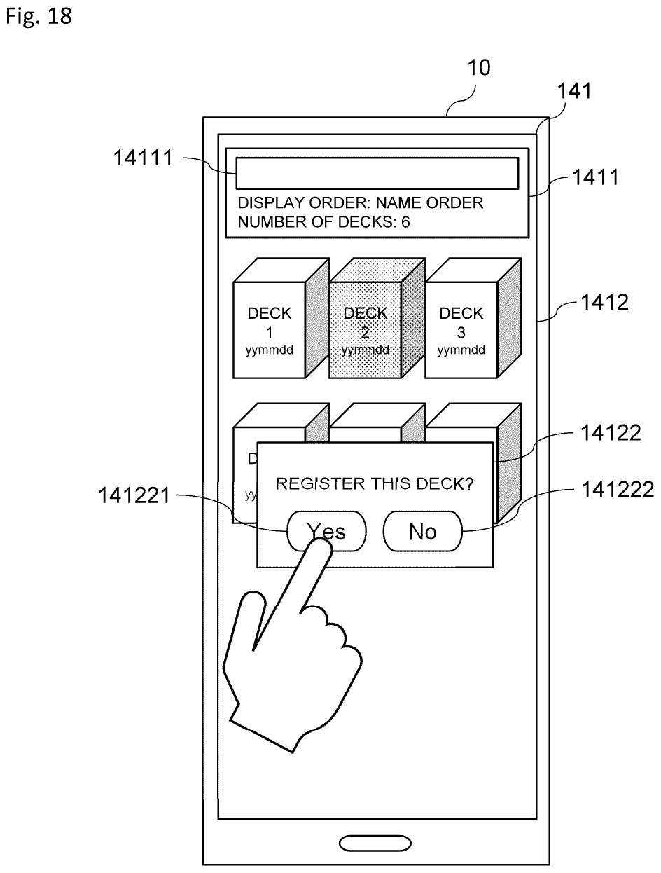

FIG. 18 is a schematic view showing a display example of the display 141. In the example shown in FIG. 18, the display control unit 194 displays a window 14122 for confirming the registration of the deck. In the window 14122, buttons 141221 and 141222 for inputting a user's intention are displayed. When it is confirmed that the deck is to be registered, the user depresses the Yes button 141221. In the present embodiment, the depression of the button 141221 means the entry of a registration request.

In step S11, the terminal device 10 receives the deck registration request input from the user, through the operation reception unit 191. The terminal device 10 transmits the received registration request to the server 20 through the transmission/reception unit 192.

In step S12, the server 20 registers the deck on the basis of a request to register the deck from the user. Specifically, for example, the control unit 203 of the server 20 creates a record of a newly organized deck in the deck information table 2023 by the management module 2033 from among decks requested to be registered.

The management module 2033 associates the newly organized deck with the creator of the deck. Specifically, for example, the management module 2033 stores the user ID of the creator of the deck in the item “creator” of the newly created record.

For a registration request for a deck that is not new, the management module 2033 associates the user who has requested the registration with an existing deck requested to be registered. For example, the management module 2033 stores the user ID of the user who has requested the registration in the item “registrant” of a record of the existing deck requested to be registered.

In step S13, the management module 2033 sets the publication range of the registered deck. Specifically, the management module 2033 asks the user who has registered the deck to confirm, for example, whether to publish the registered deck to other users.

When the user intends to publish the deck to other users, the management module 2033 manages the deck such that the deck is accessible to other users. For example, the management module 2033 stores a circle in the item “publication” in the deck information table 2023.

When the user does not intend to publish the deck to other users, the management module 2033 manages the deck such that the deck is inaccessible to other users. For example, the management module 2033 stores a cross in the item “publication” in the deck information table 2023.

In the user information table 2021, other users followed by the user are registered. When a deck is registered by a predetermined user, the management module 2033 may notify users following the predetermined user that the new deck has been registered by the user. There is a user proficient in constructing a new deck. Other users can recognize the current trend of decks by following such a user.

### (Detailed Processing 1 in Deck Registration)

The processing of the control unit 203 in step S12 of FIG. 17 will be described in detail.

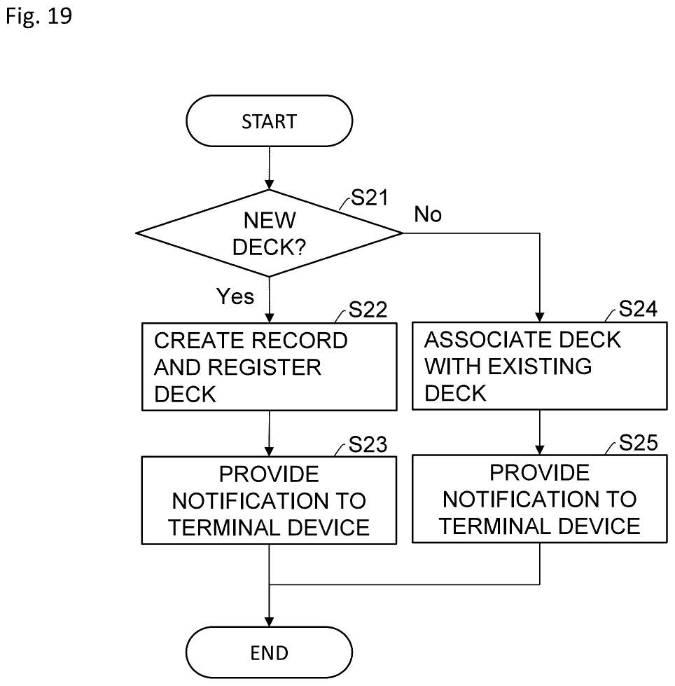

FIG. 19 is a flowchart showing an operation example of the server 20 when a deck is registered.

In step S21, the control unit 203 of the server 20 determines whether the deck requested to be registered is a new deck by means of the management module 2033. Specifically, the management module 2033 determines whether at least some of the cards for organizing the deck are different from the cards for organizing an existing deck. The management module 2033 may determine the presence or absence of a deck having exactly the same configuration or determine the presence or absence of a deck configured such that the degree of matching satisfies a certain condition. In the following example, no deck has exactly the same configuration.

If no deck has exactly the same configuration, the management module 2033 determines that the deck requested to be registered is a new deck, and advances the processing to step S22.

In step S22, the management module 2033 creates a new record in the deck information table 2023 and assigns the deck code to the created record. The management module 2033 stores information about the requested deck in the created record. The management module 2033 stores, for example, the name of the created record and the organization card on the basis of information input from the user. The management module 2033 further associates the newly created deck record with the user who has requested the registration of the deck. Specifically, the management module 2033 stores the user ID of the user who has requested the registration of the deck in the item “creator” in the record, and stores, in the item “creation date”, the date on which it was determined that the requested deck is new.

In step S23, the transmission control module 2032 notifies the terminal device 10 that the deck requested to be registered has been registered. Specifically, the transmission control module 2032 transmits the registration of the deck requested to be registered and the deck code of the registered deck to the terminal device 10 from which the registration has been requested.

When receiving the notification from the server 20, the control unit 190 of the terminal device 10 indicates on the display 141 that the deck has been registered and the user has been associated with the deck as a creator, by means of the display control unit 194. The display control unit 194 may indicate on the display 141 that the deck requested to be registered has been registered because the deck has a new configuration. The control unit 190 also associates the deck code with the corresponding record in the deck information 183 by means of the management unit 193. Thus, the display control unit 194 can indicate that the stored deck is the registered deck in the server 20.

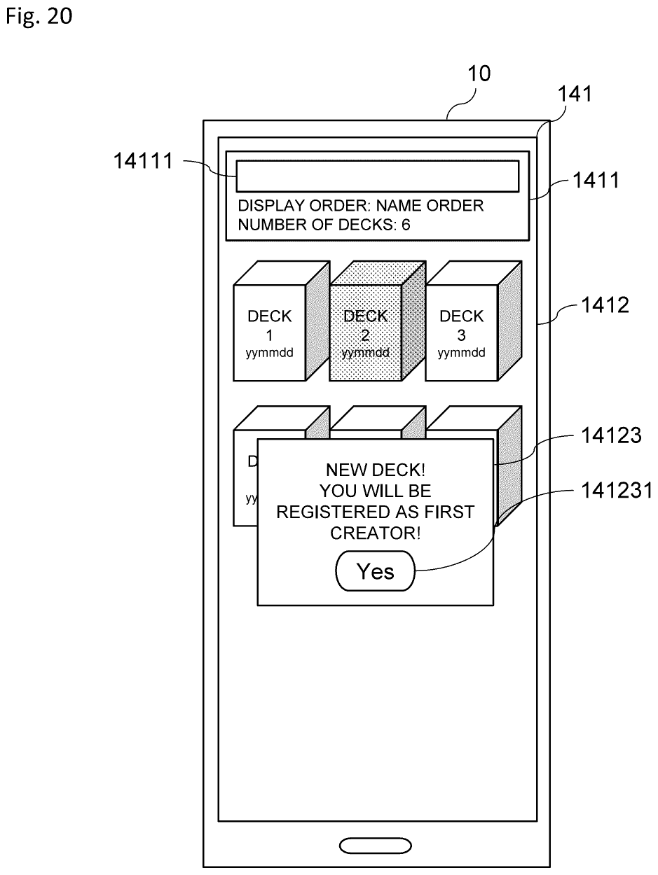

FIG. 20 is a schematic view showing a display example of the display 141. In the example shown in FIG. 20, the display control unit 194 displays a window 14123 for notifying that the deck has been registered and the user is associated with the deck as a creator. The expression of a current form or a past form in the window 14123 is not limited. The window 14123 displays a button 141231 for inputting the confirmation of the notification. When the user confirms the content of the notification, the user depresses the confirmation button 141231.

In step S13 of FIG. 17, the terminal device 10 receives, from the user, a selection as to whether to publish the registered deck to other users. Specifically, the display control unit 194 displays an image on the display 141 to receive a selection as to whether to publish the registered deck to other users.

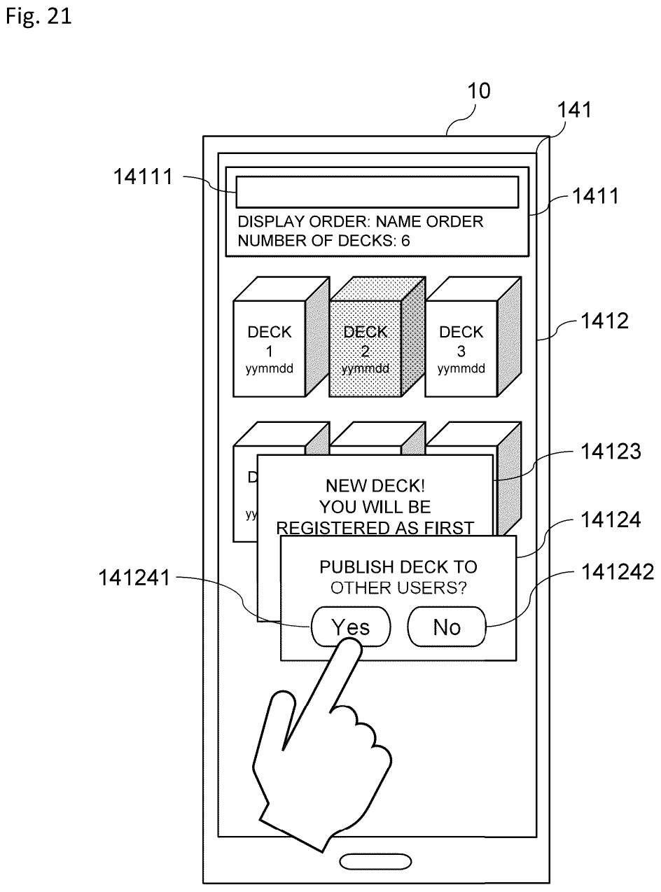

FIG. 21 is a schematic view showing a display example of the display 141. For example, when the user depresses the confirmation button 141231 on the screen shown in FIG. 20, the display control unit 194 displays a window 14124 for receiving a selection of publication to other users. In the window 14124, buttons 141241 and 141242 for inputting a user's intention are displayed. When the deck is published also to other users, the user depresses a Yes button 141241. The transmission/reception unit 192 transmits an instruction about the publication of the deck to the server 20.

When receiving an instruction about the publication of the deck, the server 20 stores information about the publication in the item “publication” in the deck information table 2023 by means of the management module 2033. Thus, when a circle is stored in the item “publication”, other users can also confirm the deck organization and the creator. When a cross is stored in the item “publication”, only the user serving as the creator can confirm the deck organization and the creator.

In step S21, if the deck requested to be registered is not a new deck, the management module 2033 advances the processing to step S24.

In step S24, the management module 2033 associates, for example, the user having requested the registration with an existing deck. Specifically, for example, the management module 2033 refers to the deck information table 2023 to obtain the same deck as the deck requested to be registered. The management module 2033 stores the user ID of the user who has requested the registration in the record of the acquired deck. This can associate the existing deck with the user who has requested the registration.

In step S24, the transmission control module 2032 notifies the terminal device 10 that the deck requested to be registered has already been present. Specifically, the transmission control module 2032 transmits the same deck having already been present and the deck code of the existing deck to the terminal device 10 from which the registration has been requested. The transmission control module 2032 may transmit the user ID of the user who created the existing deck to the terminal device 10 from which the registration has been requested. Thus, the presence of the user who has created the deck increases and can be a motive for creating the deck in advance.

When receiving the notification from the server 20, the control unit 190 of the terminal device 10 indicates on the display 141 that the deck has been already present, by means of the display control unit 194. The control unit 190 also associates the deck code of the existing deck with the corresponding record in the deck information 183 by means of the management unit 193. Thus, the display control unit 194 can indicate that the stored deck is the registered deck in the server 20.

The processing in step S24 is not always necessary. If the existing deck and the user do not need to be associated with each other, the processing of step S24 may be skipped. In other words, if the existing deck and the user do not need to be associated with each other, for example, if it is determined in step S21 that the deck requested to be registered is not a new deck, the transmission control module 2032 notifies the terminal device 10 that the deck has already been present.

### (Detailed Processing 2 in Deck Registration)

Another example of the processing of the control unit 203 in step S12 of FIG. 17 will be described in detail. In detailed processing 1, when the deck requested to be registered is a new deck, the user who has requested the registration is associated with the deck information as a creator. In detail processing 2, multiple conditions for registration as a new creator of the deck will be described.

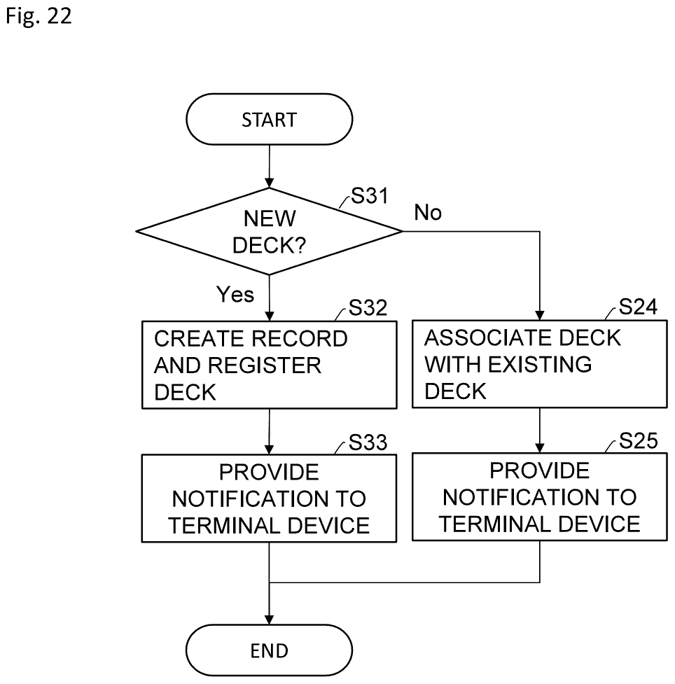

FIG. 22 is a flowchart showing an operation example of the server 20 when a deck is registered.

In step S31, the control unit 203 of the server 20 determines whether the deck requested to be registered is a new deck by means of the management module 2033. If no deck has exactly the same configuration, the management module 2033 determines that the deck requested to be registered is a new deck, and advances the processing to step S32.

In step S32, the management module 2033 creates a new record in the deck information table 2023 and assigns a deck code to the created record. The management module 2033 stores information about the requested deck in the created record. The management module 2033 stores, for example, the name of the created record and the organization card on the basis of information input from the user. The flow shown in FIG. 22 is different from the flow shown in FIG. 19, and the management module 2033 in step S32 does not store information in the item “creator” of the newly created deck record and the item “creation date”. The management module 2033 stores information (e.g., user ID) about the user who has requested the registration of the deck in the predetermined items of the created record. Thus, the management module 2033 can store the user who has transmitted the deck registration request.

In step S33, the transmission control module 2032 notifies the terminal device 10 that the deck requested to be registered has been registered. Specifically, the transmission control module 2032 transmits a notification that the deck requested to be registered is a deck having a new configuration, a notification that the user is associated with the deck as a creator of the deck when a predetermined requirement is satisfied by using the deck, and the deck code of the registered deck to the terminal device 10 from which the registration has been requested.

When receiving the notification from the server 20, the control unit 190 of the terminal device 10 causes the display control unit 194 to indicate on the display 141 that the deck is newly organized and the user is associated with the deck as a creator of the deck when the predetermined requirement is satisfied. The control unit 190 also associates the deck code with the corresponding record in the deck information 183 by means of the management unit 193. Thus, the display control unit 194 can indicate that the stored deck is the registered deck in the server 20 and the user is registered as a creator by satisfying the predetermined requirement.

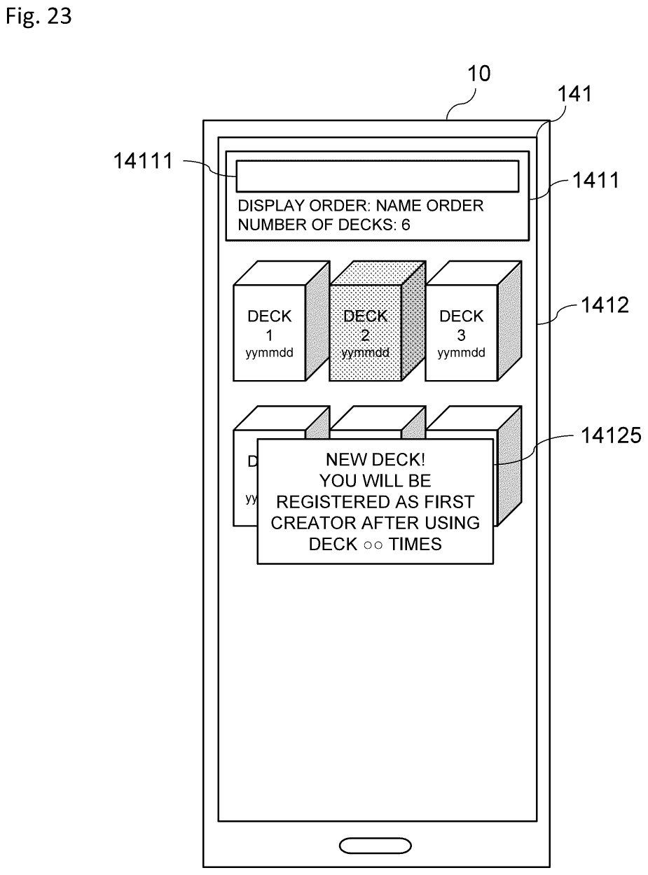

FIG. 23 is a schematic view showing a display example of the display 141. In the example shown in FIG. 23, the display control unit 194 displays a window 14125 for notifying that the deck is a new deck and the user is associated with the deck as a creator by satisfying the predetermined requirement. The window 14125 may display a button for inputting the confirmation of the notification.

If the deck requested to be registered is not a new deck in step S31, the management module 2033 advances the processing to step S24.

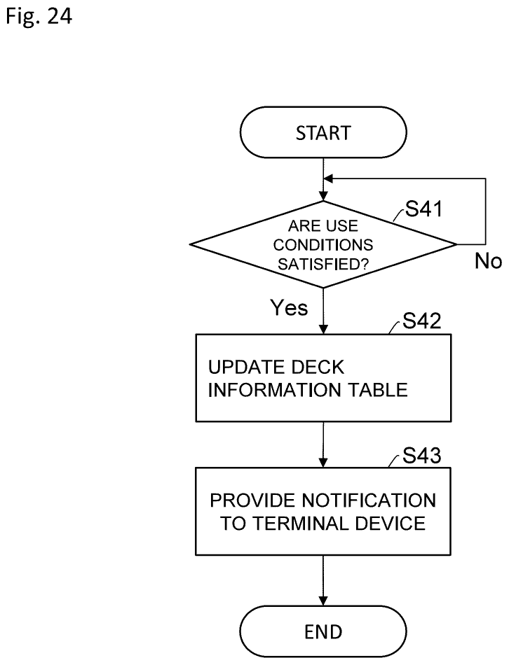

FIG. 24 is a flowchart showing an operation example of the server 20 when the deck and the creator of the deck are associated with each other.

In step S41, the management module 2033 determines whether use conditions for a new deck are met. Specifically, for example, the management module 2033 refers to the deck information table 2023 and reads information about the item “battle information” for a deck for which a record has been created but the creator is not stored. The management module 2033 determines whether the read information meets predetermined conditions for use of the deck. In other words, the management module 2033 determines whether the predetermined conditions are satisfied by using the deck by the user who has requested the registration. In the present embodiment, for example, the predetermined conditions for use of the deck include:
The number of battles using the deck has reached a predetermined number of times
The number of wins in battles using the deck has reached a predetermined number of times
Registration of the use of the deck in a predetermined tournament
The number of times of participation in a predetermined tournament has reached a predetermined number of times
The number of entries in a predetermined tournament has reached a predetermined number of times
Acquisition of a predetermined rank in a predetermined tournament.
After the publication of the deck, a user other than the user who has requested registration has met the above conditions by using the deck

If the read information satisfies the predetermined conditions for use of the deck, the management module 2033 advances the processing to step S42.

In step S42, the management module 2033 updates the deck information table 2023 for the deck that satisfies predetermined use conditions. Specifically, for example, the management module 2033 stores the user of the deck, in other words, the user ID of the user who first created the deck, in the item “creator” of a record in which information about the item “battle information” is read. In other words, the management module 2033 associates the deck that satisfies the predetermined use conditions with the creator of the deck.

In step S43, the transmission control module 2032 notifies the terminal device 10 that the user has been registered as a creator of the deck. Specifically, the transmission control module 2032 transmits a notification that the user has been registered as a creator of the deck and the deck code of the deck for which the user has been registered as a creator, to the terminal device 10 from which the registration of the deck has been requested.

When receiving the notification from the server 20, the control unit 190 of the terminal device 10 indicates on the display 141 that the user has been associated with the registered deck as a creator, by means of the display control unit 194. The display control unit 194 may display the use conditions met for the deck on the display 141. The control unit 190 stores the user as a creator in the corresponding record in the deck information 183 by means of the management unit 193. Thus, the display control unit 194 can indicate that the stored deck has been first created by the user.

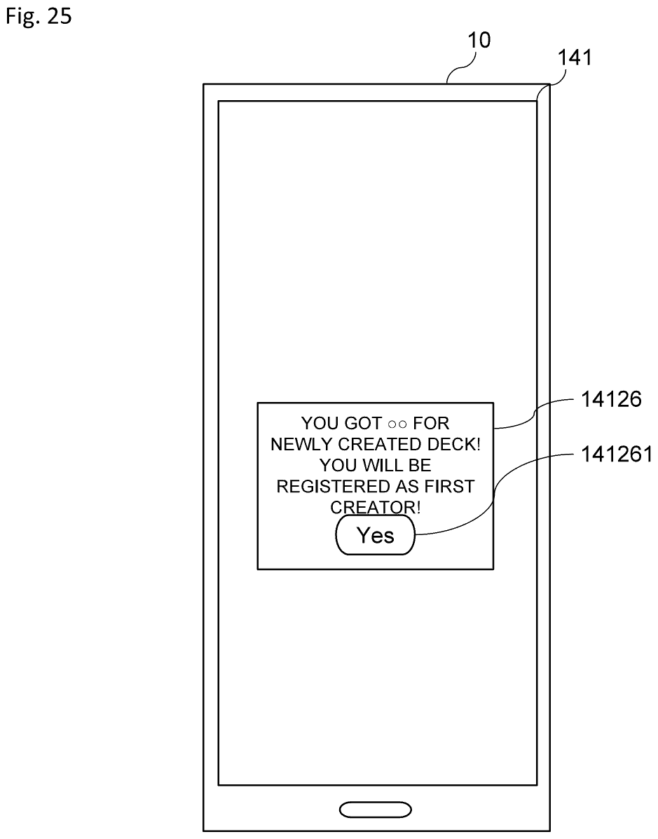

FIG. 25 is a schematic view showing a display example of the display 141. In the example shown in FIG. 25, the display control unit 194 displays a window 14126 for notifying that the user has been associated as a creator by satisfying the user conditions. The expression of a current form or a past form in the window 14126 is not limited. The window 14126 displays a button 141261 for inputting the confirmation of the notification. When the user confirms the content of the notification, the user depresses the confirmation button 141261.

When the user depresses the confirmation button 141261 on the screen shown in FIG. 25, the display control unit 194 displays, for example, a window for receiving a selection of publication to other users.

In step S41, when the use conditions for a new deck are not satisfied, the control unit 203 repeats the processing of step S41. If the conditions are not satisfied in a preset period, the management module 2033 may delete a record for a new deck.

### (Updating of Battle Information Table)

The control unit 203 of the server 20 manages information about decks used in a battle by means of the management module 2033.

The user constructs the deck by combining the cards managed by the card information 182. The management unit 193 manages information about the decks constructed by the user using the deck information 183.

Furthermore, the user registers the deck constructed by the user in the server 20. Specifically, for example, the user operates the terminal device 10 as shown in the “deck registration” to register the decks constructed by the user in the server 20.

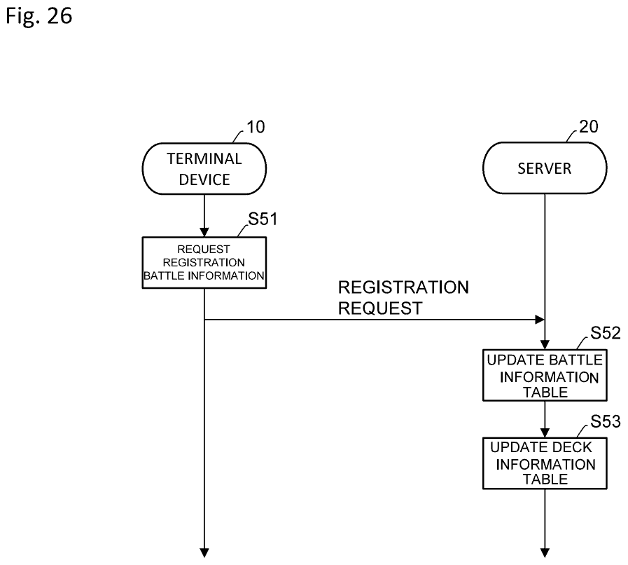

FIG. 26 is an explanatory drawing showing an operation example of the terminal device 10 and the server 20 when battle information about the deck is managed.

At the start of a battle, the user accesses the server 20 by using the terminal device 10. The terminal device 10 displays the registration form of battle information on the display 141, the registration form being set by the server 20. The user inputs information about the battle by using the form displayed on the display 141. The information about the battle includes, for example, the date and time of the battle, an opponent, information about decks used in the battle, and tournament information. When inputting the information about the battle, the user inputs a request to register the battle information to the terminal device 10.

In step S51, the terminal device 10 receives the request input to register the battle information from the user, through the operation reception unit 191. The terminal device 10 transmits the input battle information and the registration request to the server 20 through the transmission/reception unit 192.

In step S52, the server 20 updates the battle information table 2024 on the basis of the battle information input from the user. Specifically, for example, when receiving the request to register the battle information from the user, the management module 2033 issues a battle ID and creates a record in which the issued battle ID serves as a key in the battle information table 2024. The management module 2033 stores the date and time of the created record, an opponent, a deck code, and tournament information on the basis of information input from the user.

The date and time, the opponent, and the tournament information may be input in advance by a tournament organizer. In this case, the battle ID has already been issued, and the record has been created in the battle information table 2024. In addition, information about decks used in the battle may be pre-registered by the user. For example, multiple decks scheduled to be used in the tournament have been registered prior to the battle, and the user may select any one of the registered decks at the start of the battle.

In step S53, the management module 2033 updates the deck information table 2023. Specifically, the management module 2033 stores information about the battle, for example, the battle ID in the item “battle information” of the record of the deck identified by the deck code. The information about the battle using the deck may include information about the tournament in which the user has participated and information about the result of the tournament in which the user has participated. The amount of battle information to be stored increases with the number of battles. This can recognize which one of the battles has used the deck.

The server 20 may transmit information managed in the deck information table 2023 to the terminal device 10. Specifically, for example, when a new battle ID is stored in the item “battle information” of the battle information table 2024, the management module 2033 reads the additionally stored battle ID and the user ID associated with the deck. The transmission control module 2032 transmits the read battle ID to the terminal device 10 owned by the user identified by the user ID.

The terminal device 10 receives the information transmitted from the server 20, and updates the deck information 183 on the basis of the received information. Specifically, for example, in the terminal device 10, the management unit 193 stores the battle information received from the server 20, for example, the battle ID in the item “battle information” of the record identified by the deck code. Thus, the display control unit 194 can display, for the user, information about the use of the deck.

At the start of a battle, in the control unit 203, the battle processing module 2035 controls battle processing between players. The battle processing module 2035 stores, in the storage unit 202, information about techniques adopted by the player during the battle. The management module 2033 stores the information about techniques adopted by the player during the battle, as battle log information in the battle information table 2024. At the end of the battle, the battle processing module 2035 recognizes the winning player in the battle as a winner. The management module 2033 stores the winner in the battle information table 2024.

### (Bonus Offering Processing)

The offer module 2034 offers a bonus to the user on the basis of the bonus information table 2025.

Specifically, for example, the offer module 2034 determines whether information about the deck satisfies conditions set in the bonus information table 2025. For example, conditions are set in the bonus information table 2025 as follows:
The degree of contribution of the registered deck to other users meets predetermined conditions
The degree of contribution of the user to other users meets predetermined conditions

Specifically, for example, when the degree of contribution of the registered deck to other users reaches a predetermined value on the basis of the bonus information table 2025, the offer module 2034 offers a bonus to the user who first created the deck (the user registered as a creator). The degree of contribution of the deck to other users includes, for example, the number of times that other users have viewed the deck, the number of times that other users have referred to the deck, the number of times that other users have registered the deck, and the number of uses of the deck by other users.

When the degree of contribution of the user to other users reaches a predetermined value on the basis of the bonus information table 2025, the offer module 2034 offers a bonus to the user. The degree of contribution of the user to other users includes, for example, the number of times of creation of a new deck and the number of persons following the user among other users.

In the bonus information table 2025, a predetermined bonus content is set for each condition. For example, the bonus contents are set as follows:
Provision of a card
Offering the right to create an original card.
Offering the right to draw lots for cards
Advantageous effect in a battle
Advantageous effect in drawing lots for cards

The server 20 may present the degree of contribution of the registered deck to other users to the user or other users. Specifically, the transmission control module 2032 transmits, in response to a request from the user or other users, information about the degree of contribution of the registered deck to other users to the terminal device 10 from which the transmission has been requested. The terminal device 10 displays the degree of contribution on the display 141 on the basis of the received information. Thus, the user can recognize the degree of contribution before a bonus is offered. Furthermore, other users can recognize the degree of usability of the deck for others.

The server 20 may present, to the user or other users, the degree of contribution of the user to other users. Specifically, the transmission control module 2032 transmits, in response to a request from the user or other users, information about the degree of contribution of the user to other users to the terminal device 10 from which the transmission has been requested. The terminal device 10 displays the degree of contribution on the display 141 on the basis of the received information. Thus, the user can recognize the degree of contribution before a bonus is offered. Furthermore, other users can recognize the degree of effectiveness of the deck created by the user.

### (Display of Deck Information)

The terminal device 10 displays a list of decks registered in the server 20, in response to an instruction from the user. The control unit 190 of the terminal device 10 displays the list of the registered decks on the display 141 by means of the display control unit 194 on the basis of the deck information table 2023.

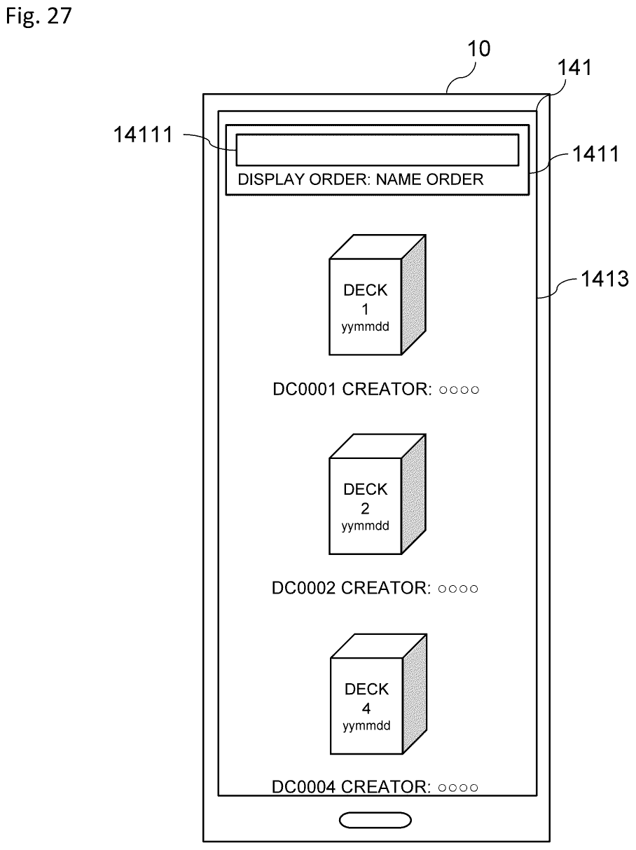

FIG. 27 is a schematic view showing a display example of the display 141. In FIG. 27, the display control unit 194 displays the area 1411 and the area 1413. The area 1411 is an area that describes display conditions or the like. The area 1413 is an area in which registered decks are displayed in a mode conforming to display conditions shown in the area 1411.

In the example shown in FIG. 27, the display order is displayed as a display condition in the area 1411. The display order represents the rule of order. The display order is selected by the user from, for example, the numeric order, the name order, the rarity order, and the acquisition date order. The display order can be switched, for example, from the numeric order to the name order, the rarity order, or the acquisition date order on the basis of an instruction from the user. In the example shown in FIG. 27, “Display order: name order” is selected, and the decks are arranged in the order of arrangement of names in the area 1413.

When the user selects the deck displayed in the area 1413, the display control unit 194 displays a list of cards constructing the selected deck on the display 141.

As described above, in the foregoing embodiment, the control unit 203 of the server 20 receives a request to register the deck created by combining a plurality of digital cards from a first player, by means of the reception control module 2031. The control unit 203 determines whether the deck requested to be registered satisfies predetermined conditions including the condition that the deck has been first created, by means of the management module 2033. When the predetermined conditions are satisfied, the management module 2033 registers the deck in association with the first player who has first created the deck. The management module 2033 enables a second player to access the registered information about the deck and the deck information to include information about the first player who created the deck. Thus, the deck that meets the predetermined conditions including the condition that the deck has been first created is registered with the creator. Thus, the player is motivated to create the deck to register the name of the player with the deck.

Accordingly, the program according to the present embodiment can improve the fun of creating the deck by the player.

Furthermore, in the foregoing embodiment, the management module 2033 allows the predetermined conditions to include the use conditions of the first created deck. Thus, the player is not registered only by creating the deck. The player is registered when the created deck is actually used. Therefore, if the deck is created only for the purpose of registering the deck, no player is registered. In other words, information about the deck that is practically usable and is valuable for other players is registered with the player.

Furthermore, in the foregoing embodiment, the management module 2033 allows the use conditions of the first created deck to include the number of battles using the deck, the number of wins in battles using the deck, the number of entries of the deck in a predetermined tournament, or the acquisition of a predetermined rank of the first player using the deck in the predetermined tournament. Thus, when the practical use conditions are satisfied, the player is registered with the deck.

Moreover, in the foregoing embodiment, when a deck created by a predetermined player is registered, the management module 2033 notifies other players that the deck created by the player has been newly registered. This can keep track of a deck created by a player proficient in creating a new deck or a famous player, thereby recognizing the trend of deck creation.

Furthermore, in the foregoing embodiment, the offer module 2034 offers a bonus to the first player (the creator of the deck) on the basis of the degree of contribution of the registered deck to the second player (another player). This may motivate the player to create decks useful for other players.

Moreover, in the foregoing embodiment, the offer module 2034 offers a bonus to the first player on the basis of the degree of contribution of the first player (the creator of the deck) to the second player (another player). This allows the first player who created a large number of new decks to receive a bonus, which may motivate the player to create decks.

### Modification Examples

In the foregoing embodiment, the user information table 2021, the card master table 2022, the deck information table 2023, the battle information table 2024, and the bonus information table 2025 are stored in the server 20. However, the information stored in these tables may not be stored in the server 20. For example, at least deck information stored in the deck information table 2023 may be stored in a blockchain (distributed ledger) formed by a peer-to-peer computer network.

At this time, each digital card is traded as a non-fungible token (NFT) in a blockchain. The NFT in the foregoing embodiment is assigned with, for example, a unique identifier (NFT-ID) for identifying the NFT. Each deck may be traded as an NFT in the blockchain.

Trading of the NFT is performed by, for example, a smart contract implemented in a blockchain. The trading history for the NET is stored as a transaction in the blockchain. Thus, the history of NFT owners is stored in the blockchain.

In addition, management for the use of the NFT is performed by, for example, a smart contract implemented in the blockchain. The usage history of the NFT is stored as a transaction in the blockchain. Thus, the usage history of the NFT in battles is stored in the blockchain.

Furthermore, a bonus for the creation of the deck is offered by, for example, a smart contract implemented in the blockchain. Thus, when the history of deck creation meets a predetermined requirement, a predetermined bonus is offered to the creator of the deck.

In this way, the control unit 203 of the server 20 stores information about the deck in a distributed ledger, which is formed by a computer network, by means of the management module 2033. Specifically, information about a plurality of digital cards constructing the deck and information about the first player are stored in the distributed ledger. Alternatively, the control unit 190 of the terminal device 10 may store information about the deck in the distributed ledger, which is formed by a computer network, by means of the management unit 193. Thus, the deck can be handled as an NFT. Moreover, a clear record of the newly created deck can be kept.

In the foregoing embodiment, the server 20 stores the battle information table 2024. Battle information about the user may be stored in the storage unit 180 of the terminal device 10. The management unit 193 may update battle information in the deck information 183 on the basis of the battle information stored in the storage unit 180. When the deck information 183 is updated, the transmission/reception unit 192 transmits the information about the deck to the server 20. The management module 2033 of the server 20 updates the deck information table 2023 on the basis of information transmitted from the terminal device 10. Thus, the terminal device 10 can recognize the battle information.

In the foregoing embodiment, when the deck is new, information about the deck is stored in the deck information table 2023. However, if the deck meets only the condition that the deck is new, the information about the deck may not be stored in the deck information table 2023. For example, the management module 2033 may store information in the deck information table 2023 if the deck is new and the deck meets other conditions. In this case, for example, the management module 2033 stores information about the deck determined to be new in a predetermined storage area other than the deck information table 2023 and stores information in the deck information table 2023 when, for example, the use conditions of the deck are satisfied.

In the foregoing embodiment, the user who first registered the deck is registered as a creator. However, the user registered as a creator is not limited to only the user who first registered the deck. For example, the management module 2033 may widely include users to be registered as creators. Specifically, in addition to the user who first registered the deck, a user who noticed the strength of the deck early on and gained some form of fame may also be registered as a creator. Hence, “creators” are persons who have acquired fame for themselves and can be distinguished from “registrants” who have obtained the benefit from the wisdom of “creators”. Specifically, for example, the management module 2033 also registers the first X users who requested the registration of the deck as creators. Alternatively, the management module 2033 may register the top X % users who first applied for the registration of the deck from among users who applied for the registration of the deck.

### <4 Basic Hardware Configuration of Computer>

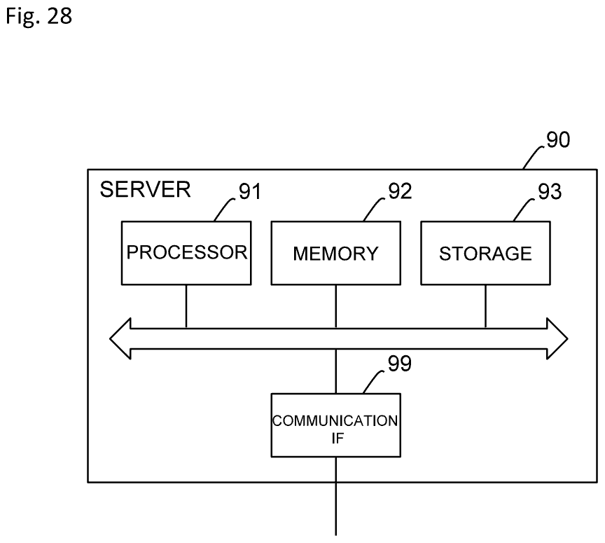

FIG. 28 is a block diagram illustrating a basic hardware configuration of a computer 90. The computer 90 includes at least a processor 91, a main storage device 92, an auxiliary storage device 93, and a communication IF 99 (Interface). These components are electrically connected to one another via a communication bus.

The processor 91 is a hardware for executing a command set described in a program. The processor 91 is configured of an arithmetic operation device, a register, a peripheral circuit, and the like.

The main storage device 92 is adapted to temporarily store a program and data processed by the program or the like. For example, the main storage device 92 is a volatile memory such as a dynamic random access memory (DRAM).

The auxiliary storage device 93 is a storage device adapted to save data and programs. For example, the auxiliary storage device is a flash memory, a hard disc drive (HDD), a magneto-optical disk, a CD-ROM, a DVD-ROM, or a semiconductor memory.

The communication IF 99 is an interface adapted to input and output signals to communicate with other computers via a network using a wired or wireless communication standard.

The network is configured with various mobile communication systems constructed by the Internet, a LAN, and a wireless base station or the like. For example, the network includes 3G, 4G, and 5G mobile communication systems, Long Term Evolution (LTE), a wireless network (e.g., Wi-Fi (registered trademark)) that can be connected to the Internet by a predetermined access point. In the case of wireless connection, communication protocols include, for example, Z-Wave (registered trademark), ZigBee (registered trademark), and Bluetooth (registered trademark). In the case of wired connection, the network includes a network directly connected via a universal serial bus (USB) cable.

Note that the computer 90 can be virtually implemented by providing all or some of hardware configurations in a distributed manner in the plurality of computers 90 and connecting the computers 90 via a network. In this manner, the computer 90 is a concept that includes not only the computer 90 accommodated in a single casing or case but also a virtualized computer system.

### <Basic Functional Configuration of Computer 90>

The functional configuration of a computer implemented by the basic hardware configuration of the computer 90 in FIG. 28 will be described below. The computer includes at least functional units of a control unit, a storage unit, and a communication unit.

Note that the functional units included in the computer 90 can also be implemented by providing all or some of the functional units in a distributed manner in the plurality of computers 90 connected to one another via a network. The computer 90 is a concept that includes not only a single computer 90 but also a virtualized computer system.

The control unit is implemented by the processor 91 reading various programs stored in the auxiliary storage device 93, deploying the programs on the main storage device 92, and executing processing in accordance with the programs. The control unit can implement functional units that perform various kinds of information processing in accordance with the types of the programs. In this manner, the computer is implemented as an information processing device that performs information processing.

The storage unit is implemented by the main storage device 92 and the auxiliary storage device 93. The storage unit stores data, various programs, and various databases. Also, the processor 91 can secure a storage region corresponding to the storage unit in the main storage device 92 or the auxiliary storage device 93 in accordance with the programs. In addition, the control unit can cause the processor 91 to execute addition, update, and deletion processing of data stored in the storage unit in accordance with the various programs.

A database refers to a relational database and is adapted to manage data sets in a mutually associated manner, the data set being referred to as a tabular table structurally defined by rows and columns. In a database, a chart is called a table, a chart column is called a column, and a chart row is called a record. In a relational database, the relationship between tables can be set and the tables can be associated with each other.

Although a column as a key for uniquely specifying a record is typically set in each table, the setting of the key for the column is not always necessary. The control unit can cause the processor 91 to execute addition, deletion, and update of a record in a specific table, which is stored in the storage unit, in accordance with the various programs.

The communication unit is implemented by the communication IF 99. The communication unit implements the function of communicating with other computers 90 via a network. The communication unit can receive information transmitted from other computers 90 and input the information to the control unit. The control unit can cause the processor 91 to execute information processing on the received information in accordance with the various programs. Also, the communication unit can transmit information output from the control unit to other computers 90.

Although several embodiments of the present disclosure have been described above, these embodiments can be implemented in various other forms, and various omissions, replacements, and changes can be performed without departing from the spirit of the disclosure. These embodiments or modifications thereof are intended to be included in the in the claims and equivalents thereof, as being included in the scope or gist of the disclosure.

### APPENDICES

Matters described in each of the above embodiments will be appended below.

### Appendix 1

A program to be executed by a computer including a processor and a memory, the program causing the processor to perform the steps of: receiving, from a first player, a request to register a deck created by combining a plurality of digital cards; determining whether predetermined conditions are satisfied, the predetermined conditions including the condition that the deck having received the request for registration from the first player is the first created deck; registering, if the predetermined conditions are satisfied, the deck in association with the first player who first created the deck; and allowing a second player to access information about the registered deck and the information about the deck to include information about the first player who created the deck.

### Appendix 2

The program according to (appendix 1), wherein, in the determining step, the predetermined conditions include use conditions of the first created deck.

### Appendix 3

The program according to (appendix 2), wherein the use conditions of the first created deck include at least one of the number of battles using the deck, the number of wins in battles using the deck, the number of entries of the deck in a predetermined tournament, and the acquisition of a predetermined rank of the first player using the deck in the predetermined tournament.

### Appendix 4

The program according to any one of (appendix 1) to (appendix 3), wherein in the registering step, information about the plurality of digital cards constructing the deck and information about the first player are stored in a distributed ledger formed by a computer network.

### Appendix 5

The program according to any one of (appendix 1) to (appendix 4), wherein the program causes the processor to execute the step of, when the deck created by a predetermined player is registered, notifying other players that the deck created by the player has been newly registered.

### Appendix 6

The program according to any one of (appendix 1) to (appendix 5), wherein the program causes the processor to execute the step of offering a bonus to the first player on the basis of the degree of contribution of the registered deck to the second player.

### Appendix 7

The program according to any one of (appendix 1) to (appendix 6), wherein the program causes the processor to execute the step of offering a bonus to the first player on the basis of the degree of contribution of the first player to the second player.

### Appendix 8

A method to be executed by a computer including a processor and a memory, the method performing the steps of: receiving, from a first player, a request to register a deck created by combining a plurality of digital cards; determining whether predetermined conditions are satisfied, the predetermined conditions including the condition that the deck having received the request for registration from the first player is the first created deck; registering, if the predetermined conditions are satisfied, the deck in association with the first player who first created the deck; and allowing the second player to access information about the registered deck and the information about the deck to include information about the first player who created the deck.

### Appendix 9

An information processing device including a control unit and a storage unit, the control unit performing the steps of: receiving, from a first player, a request to register a deck created by combining a plurality of digital cards; determining whether predetermined conditions are satisfied, the predetermined conditions including the condition that the deck having received the request for registration from the first player is the first created deck; registering, if the predetermined conditions are satisfied, the deck in association with the first player who first created the deck; and allowing a second player to access information about the registered deck and the information about the deck to include information about the first player who created the deck.

### Appendix 10

A system including means for receiving, from a first player, a request to register a deck created by combining a plurality of digital cards; the step of determining whether predetermined conditions are satisfied, the predetermined conditions including the condition that the deck having received the request for registration from the first player is the first created deck; means for registering, if the predetermined conditions are satisfied, the deck in association with the first player who first created the deck; and means for allowing a second player to access information about the registered deck and the information about the deck to include information about the first player who created the deck.

1. A non-transitory computer-readable storage medium storing computer-readable instructions thereon to be executed by a computer comprising a processor and a memory, the computer-readable instructions causing the processor to perform a method, the method comprising:
receiving, from a first player, a request to register a deck created by combining a plurality of digital cards;
determining whether predetermined conditions are satisfied, the predetermined conditions including a condition that the deck having received the request for registration from the first player is the first created deck;
registering, in a case that the predetermined conditions are satisfied, the deck in association with the first player who first created the deck; and
allowing a second player to access information about the registered deck and the information about the deck to include information about the first player who created the deck.

2. The non-transitory computer-readable storage medium according to claim 1, wherein the predetermined conditions include use conditions of the first created deck.

3. The non-transitory computer-readable storage medium according to claim 2, wherein the use conditions of the first created deck include at least one of the number of battles using the deck, the number of wins in battles using the deck, the number of entries of the deck in a predetermined tournament, and acquisition of a predetermined rank of the first player using the deck in the predetermined tournament.

4. The non-transitory computer-readable storage medium according to claim 1, wherein information about the plurality of digital cards constructing the deck and information about the first player are stored in a distributed ledger formed by a computer network.

5. The non-transitory computer-readable storage medium according to claim 1, further comprising:
in a case that the deck created by a predetermined player is registered, notifying other players that the deck created by the player has been newly registered.

6. The non-transitory computer-readable storage medium according to claim 1, further comprising:
offering a bonus to the first player based on a degree of contribution of the registered deck to the second player.

7. The non-transitory computer-readable storage medium according to claim 1, further comprising:
offering a bonus to the first player on a basis of a degree of contribution of the first player to the second player.

8. A method to be executed by a computer comprising a processor and a memory, the method performed by the processor comprising:
receiving, from a first player, a request to register a deck created by combining a plurality of digital cards;
determining whether predetermined conditions are satisfied, the predetermined conditions including a condition that the deck having received the request for registration from the first player is the first created deck;
registering, in a case that the predetermined conditions are satisfied, the deck in association with the first player who first created the deck; and
allowing a second player to access information about the registered deck and the information about the deck to include information about the first player who created the deck.

9. The method according to claim 8, wherein the predetermined conditions include use conditions of the first created deck.

10. The method according to claim 9, wherein the use conditions of the first created deck include at least one of the number of battles using the deck, the number of wins in battles using the deck, the number of entries of the deck in a predetermined tournament, and acquisition of a predetermined rank of the first player using the deck in the predetermined tournament.

11. The method according to claim 8, wherein information about the plurality of digital cards constructing the deck and information about the first player are stored in a distributed ledger formed by a computer network.

12. The method according to claim 8, further comprising:
in a case that the deck created by a predetermined player is registered, notifying other players that the deck created by the player has been newly registered.

13. The method according to claim 8, further comprising:
offering a bonus to the first player based on a degree of contribution of the registered deck to the second player.

14. The method according to claim 8, further comprising:
offering a bonus to the first player on a basis of a degree of contribution of the first player to the second player.

15. An information processing device, comprising:
processing circuitry configured to
receive, from a first player, a request to register a deck created by combining a plurality of digital cards;
determine whether predetermined conditions are satisfied, the predetermined conditions including a condition that the deck having received the request for registration from the first player is the first created deck;
register, if the predetermined conditions are satisfied, the deck in association with the first player who first created the deck; and
allow a second player to access information about the registered deck and the information about the deck to include information about the first player who created the deck.

16. A system comprising means for receiving, from a first player, a request to register a deck created by combining a plurality of digital cards;
the step of determining whether predetermined conditions are satisfied, the predetermined conditions including the condition that the deck having received the request for registration from the first player is the first created deck;
means for registering, if the predetermined conditions are satisfied, the deck in association with the first player who first created the deck; and
means for allowing a second player to access information about the registered deck and the information about the deck to include information about the first player who created the deck.
